(19) United States
(12) Patent Application Publication
(10) Pub. No.: US 2019/0236739 A1
(43) Pub. Date: Aug. 1, 2019

(54) LAW ENFORCEMENT ASSET MANAGEMENT SYSTEM

(71) Applicant: Joe Ganete, Hillsboro, OR (US)

(72) Inventor: Joe Ganete, Hillsboro, OR (US)

(21) Appl. No.: 16/265,509

(22) Filed: Feb. 1, 2019

Related U.S. Application Data
(60) Provisional application No. 62/625,136, filed on Feb. 1, 2018.

(51) Int. Cl. G06Q 50/26; G06F 16/22; G06F 16/25; G06F 16/27

(52) U.S. Cl. CPC G06Q 50/265; G06F 16/27; G06F 16/252; G06F 16/22

(57) ABSTRACT

Embodiments disclosed herein provide for systems and methods for, among other things, managing officer training, firearms (or other equipment) and other law enforcement activities to increase the speed and efficiency. An interconnected asset management system is provided in which data is leveraged across different functions to determine, among other things, what firearm (or other equipment) is checked out to whom, whether an issued or inventoried firearm (or other equipment) has been lost or stolen, when a firearm (or other equipment) was last serviced, when an officer to whom a firearm is checked out was trained to use the firearm and the results of any such training, and whether and when components of a firearm (or other equipment) need to be repaired, replaced or decommissioned, and what firearm components (or other equipment) are available for use in a law enforcement agency's armory.

### RELATED APPLICATIONS

The present application claims priority to U.S. Provisional Application No. 62/625,136, filed Feb. 1, 2018, entitled “Law Enforcement Asset Management System,” which is hereby incorporated by reference in its entirety.

### TECHNICAL FIELD

Embodiments herein relate generally to asset management, and more particularly to asset management systems for managing, among other things, the disbursement, maintenance, and/or training associated with firearms or equipment of a law enforcement agency.

### SUMMARY OF THE INVENTION

An asset management system includes a back-end server coupled to a user device via a network, wherein the back-end server is configured to process information associated with one or more law enforcement agencies. A database server coupled to the back-end server, wherein the database server is configured to manage one or more databases, wherein each database of the one or more databases corresponds to a unique one of the one or more law enforcement agencies, and wherein the database of the one or more databases is configured to store a portion of the information associated with the one or more law enforcement agencies that corresponds to the unique one of the one or more law enforcement agencies.

### BRIEF DESCRIPTION OF THE DRAWINGS

The written disclosure herein describes illustrative embodiments that are non-limiting and non-exhaustive. Reference is made to certain illustrative embodiments that are depicted in the figures, in which:

FIG. 1 illustrates a simplified block diagram of an asset management system consistent with embodiments of the present disclosure;

FIG. 2 illustrates a flow chart diagram of a method for use with an asset management system consistent with embodiments of the present invention;

FIG. 3 illustrates an exemplary login screen view for use with an asset management system consistent with embodiments of the present disclosure;

FIG. 4 illustrates an exemplary home screen view for use with an asset management system consistent with embodiments of the present disclosure;

FIGS. 5, 5A, 5B, 5C, 5D, 5E, 5F, 5G, 5H, 5I, 5J, 5K, 5L, 5M, 5N, 5O, 5P, 5Q, 5R, 5S, 5T and 5U illustrate exemplary screen views for use with an inventory module of an asset management system consistent with embodiments of the present disclosure;

FIGS. 6, 6A, 6B, 6C, 6D, 6D.1, 6D.2, 6E, 6F, 6G, 6H, 6I, 6J, 6K and 6L illustrate exemplary screen views for use with a training module of an asset management system consistent with embodiments of the present disclosure;

FIGS. 7, 7A, 7B, 7C, 7D, 7E, 7F, 7G, 7H, 7I, 7J, 7K, 7L, 7M, 7N, 7O, 7P, 7Q, 7R, 7S, 7T, 7U, and 7V illustrate exemplary screen views for use with an armory module of an asset management system consistent with embodiments of the present disclosure;

FIGS. 8, 8A, 8B, and 8C illustrate exemplary screen views for use with a shooting range module of an asset management system consistent with embodiments of the present disclosure;

FIGS. 9, 9A, 9B, 9C, 9D, 9E, 9F, 9G, and 9H illustrate exemplary screen views for use with an equipment module of an asset management system consistent with embodiments of the present disclosure; and

FIG. 10 illustrates an exemplary screen view for use with the locker management functions of an asset management system consistent with embodiments of the present disclosure.

### DETAILED DESCRIPTION

A detailed description of the systems and methods consistent with embodiments of the present disclosure is provided below. While several embodiments are described, it should be understood that the disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

The embodiments of the disclosure may be understood by reference to the drawings, wherein like parts may be designated by like numerals. The components of the disclosed embodiments, as generally described and illustrated in the figures herein, could be arranged and designed in a wide variety of different configurations. Thus, the following detailed description of the embodiments of the systems and methods of the disclosure is not intended to limit the scope of the disclosure, as claimed, but is merely representative of possible embodiments of the disclosure. In addition, the steps of any method disclosed herein do not necessarily need to be executed in any specific order, or even sequentially, nor need the steps be executed only once, unless otherwise specified.

In law enforcement, “agency readiness” is critical. It requires that officers, as well as their firearms and other issued equipment, are in optimal condition and ready to deploy at all times. Agency readiness may also require, among other things, knowing at any moment in time what firearm (or other equipment) is checked out to whom, whether an issued or inventoried firearm (or other equipment) has been lost or stolen, when a firearm (or other equipment) was last serviced, when an officer to whom a firearm is checked out to was trained to use the firearm and the results of any such training, whether and when components of a firearm (or other equipment) need to be repaired, replaced or decommissioned according to agency and/or manufacturer guidelines, and what firearm components (or other equipment) are available for use in an agency's armory. Agency readiness may also require securing communal firearms and/or other equipment at a remote location where no armory, armorer, or quartermaster is available to issue the firearms and/or equipment.

Embodiments disclosed herein provide for systems and methods for, among other things, managing officer training, firearms (or other equipment) and other law enforcement activities to increase the speed and efficiency. Additional benefits include, without limitation, increased agency transparency, management insight into trend analysis etc. at any moment time, increased productivity, and standards compliance capabilities. In accordance with embodiments disclosed herein, these benefits are the result of an interconnected asset management system in which data is leveraged across different functions modules) and optimized for “agency readiness.”

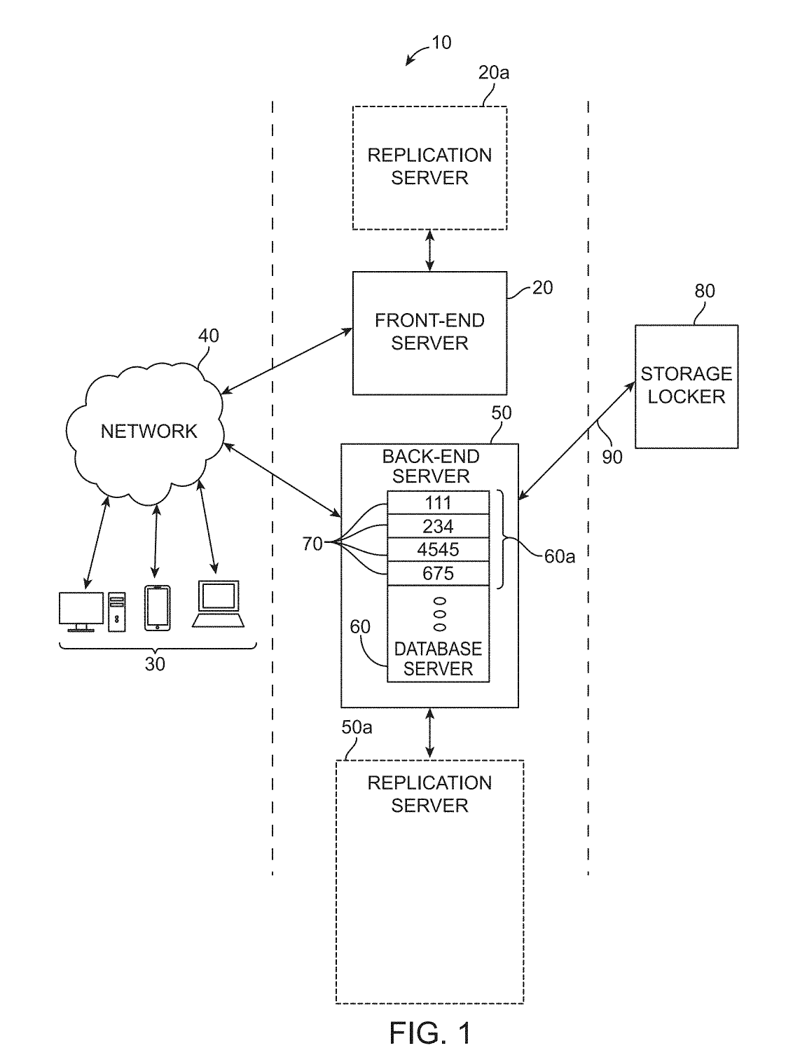

FIG. 1 illustrates a simplified block diagram of an asset management system 10 consistent with various embodiments of the present disclosure. The asset management system 10 may include a front-end server 20 and a back-end server 50, each coupled to one or more user devices 30 via a network 40 (e.g., Internet or any other network capable of communicating information between a user device 30 and the asset management system 10). A user device 30 may be physically and/or electronically connected via the network 40 to the front-end server 20 and back-end server 50. Some examples of user devices 30 include, without limitation, computing devices such as desktop and laptop computers, and portable devices such as tablets, cell phones, and the like. The asset management system 10 may include a database server 60 coupled to the back-end server 50. In some embodiments, the database server 60 may be physically or logically be divided into one or more separate databases 60a where each database 60a is associated with a particular law enforcement agency. For example, a law enforcement agency may be assigned a unique agency code 70 that is associated with a database 60a. The agency code 70 may include numeric character(s), alphabetic character(s), alpha-numeric character(s) and/or symbols e.g., 111, 234, 4545, 675, oakland, seattle, nyc, etc. The database server 60 may be on the same network or the same machine as the back-end server 50. The asset management system 10 may also include one or more replication servers 20a coupled to the front-end server 20 and/or one or more replication servers 50a coupled to the back-end server 50. Replication servers 20a may be located in the same or a different geographic location than the front-end server 20. Similarly, replication servers 50a may be located in the same or a different geographic location than the back-end server 50.

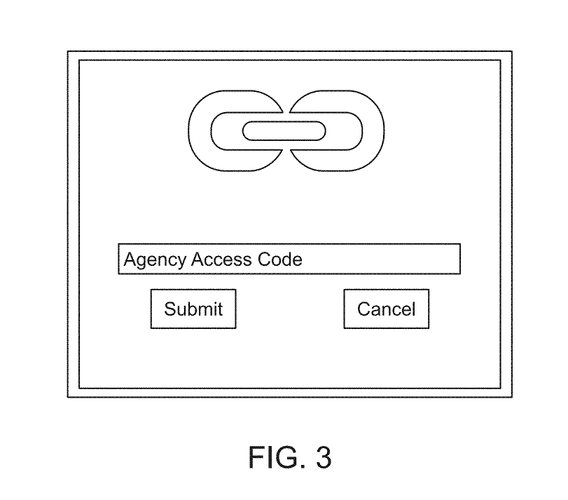

The front-end server 20 may be implemented in hardware and/or software to communicate with a user device 30 via the network 40 (e.g., Internet or other network) to, among other things, handle incoming requests for login, ticketing e.g., user authentication or proof of authorization), and/or other administrative services of the asset management system 10. For example, the front-end server 20 may present the initial login page (FIG. 3) and request agency code 70 and/or password information. Consistent with embodiments of the present disclosure, a front-end server 20 may include, without limitation, a web server, server cluster, cloud server, virtual server, or any other server capable of storing and/or processing information. The front-end server 20 may include one or more software modules executed by one or more processors and/or one or more hardware modules for providing login, ticketing, and/or other administrative services of the asset management system 10. In some embodiments, the front-end server 20 may be physically and/or electronically coupled to the back-end server 50. Additionally, the front-end server 20 may be coupled to one or more replication servers 20a to replicate the functionality of or data stored on the front-end server 20, and provide reliable, fault-tolerant, and/or accessible capabilities for the asset management system 10—a necessary prerequisite to law enforcement “agency readiness.” A replication server 20a may include, without limitation, a web server, server cluster, cloud server, virtual server, or any other server capable of storing and/or processing information.

The back-end server 50 may be implemented in hardware and/or software to communicate with a user device 30 via the network 40 (e.g., Internet or other network) to, among other things, handle incoming network requests over hypertext transfer protocol (HTTP) (or other related protocols) related to managing law enforcement agency asset information or other information, and storing such information to and/or accessing such information from a database 60a coupled to the database server 60. Consistent with embodiments of the present disclosure, the back-end server 50 may include, but is not limited to, a web server, server cluster, cloud server, virtual server, or any other server capable of storing and/or processing information. The back-end server 50 may include one or more software modules executed by one or more processors and/or one or more hardware modules for managing the assets of a law enforcement agency consistent with embodiments of the present disclosure. The back-end server 50 may be coupled to one or more replication servers 50a that may replicate, among other things, data stored in a database 60a or the functionality of the back-end server 50. This ensures that the asset management system 10 is reliable, fault-tolerant, and/or accessible. A replication server 50a may include, without limitation, a web server, server cluster, cloud server, virtual server, or any other server capable of storing and/or processing information.

As discussed above, the ability to secure communal firearms and/or equipment at a remote location where no armory, armorer, or quartermaster is available to issue firearms and/or equipment may be critical. Likewise, the ability to stage firearms and/or other equipment for repair, or provide access to firearms and/or other equipment at a remote location may be necessary. Accordingly, the back-end server 50 of FIG. 1 may be physically and/or electronically coupled to one or more storage lockers 80 via a connection 90. The connection 90 may include a landline, Bluetooth, Wi-Fi, or other connection. The back-end server 50 may include hardware-implemented and/or software-implemented functions for interfacing with one or more lockers 80. For example, a locker 80 may include a controller (not shown) that is capable of communicating with the back-end server 50 via a connection 90. The locker 80 may also include a user interface screen (or the like) (not shown) that allows an officer (or other user) to enter login information and physically access the locker 80. Once logged in, an officer (or other user) may select the asset or consumable they want to check in or out of the locker 80.

In some embodiments, the back-end server 50 may include functions to track when a locker 80 is open or closed, by whom, the date and time the opening/closing occurred, and/or information about the firearms (or other equipment) that may be assigned to the locker 80. The back-end server 50 may also include functions for assigning a locker 80 to an asset management system 10, assigning firearms (or other equipment) to a locker 80, assigning an officer to a locker 80, and/or opening or closing a locker 80. The back-end server 50 may further include functions for generating reports associated with a locker 80. For example, such reports may identify all available lockers 80 and/or their locations, the activity associated with a particular locker (or lockers) 80 by location or by officer (e.g., the activity associated with a locker 80 at a particular location, or the locker activity associated with a particular officer, etc.), the inventory contained in or assigned to a locker 80, and so on.

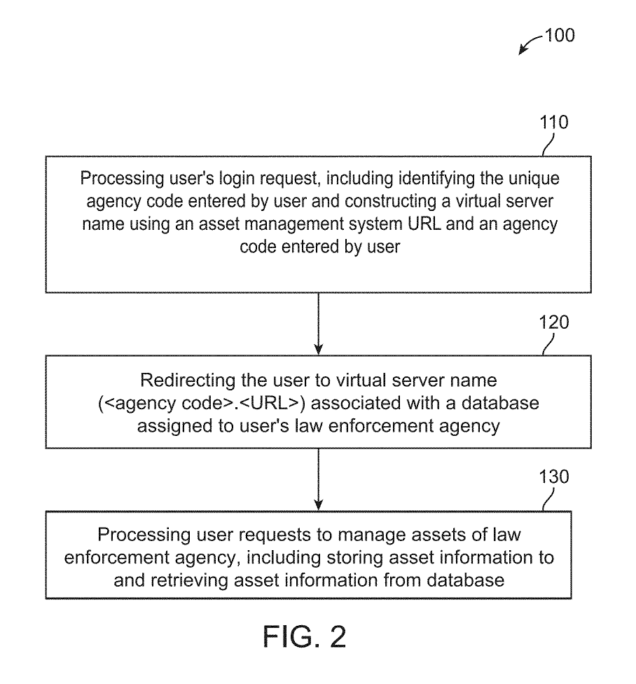

In FIG. 2, one method 100 of operating the asset management system 10 is described. For illustrative purposes, the method 100 is described with reference to FIG. 1 and exemplary graphical user interfaces (GUI) illustrated with reference to FIGS. 3 through 10. It is understood, however, that the method 100 may be implemented with asset management systems 10 other than the exemplary asset management system illustrated in FIG. 1. It is further understood that the method 100 may be implemented using GUIs other than the exemplary GUIs illustrated in FIGS. 3 through 10.

Generally, as shown in FIG. 2, a user may access an asset management system 10 from a user device 10 by using a web browser to navigate to a URL associated with an asset management system 10 (e.g., armorerlink.com) where an application program interface (API) (or other software) residing on the front-end server 20 may display a login screen (FIG. 3) on the user device 30. At step 110, the user logs in to the asset management system 10 by entering the unique agency code 70 that has been assigned to the user's law enforcement agency (FIG. 3). In some embodiments, the user may also enter a password (not shown in FIG. 3). The back-end server 50 processes the user's login request, including identifying the unique agency code 70 entered by the user and constructs a virtual server name from the URL and the agency code 70 entered by the user—e.g., <agency code>.<URL>.

At step 120, the back-end server 50 redirects the user to the virtual server name constructed from the URL and agency code 70 entered by the user. For example, if the agency code 70 entered by the user is “111” and the URL associated with the asset management system 10 is “www.armorerlink.com,” the back-end server 50 will redirect the user to virtual server name “111.armorerlink.com.” The virtual server name may be associated with the database server 60 and, more particularly, with a database 60a assigned to the law enforcement agency assigned agency code “111.” By physically or logically dividing the database server 60 into one or more separate databases 60a where each database 60a is associated with a unique law enforcement agency, the asset management system 10 may simultaneously provide asset management functions to multiple disparate law enforcement agencies. Moreover, by dividing the database server 60 by agency codes 70, the asset management system 10 can more easily split law enforcement agencies off to their own server. For example, if a law enforcement agency is particularly busy and/or needs custom built software and/or hardware, their database 60a can easily be moved to separate virtual or physical server. Additionally, in some embodiments, multiple separate databases 60a can be set up for the same law enforcement agency, where one database 60a is located on one server, and another database 60a is located on a server in an entirely different geographic location. This provides a natural disaster and the like backup. It also avoids having an expensive load balancer at the front of the back-end server 50.

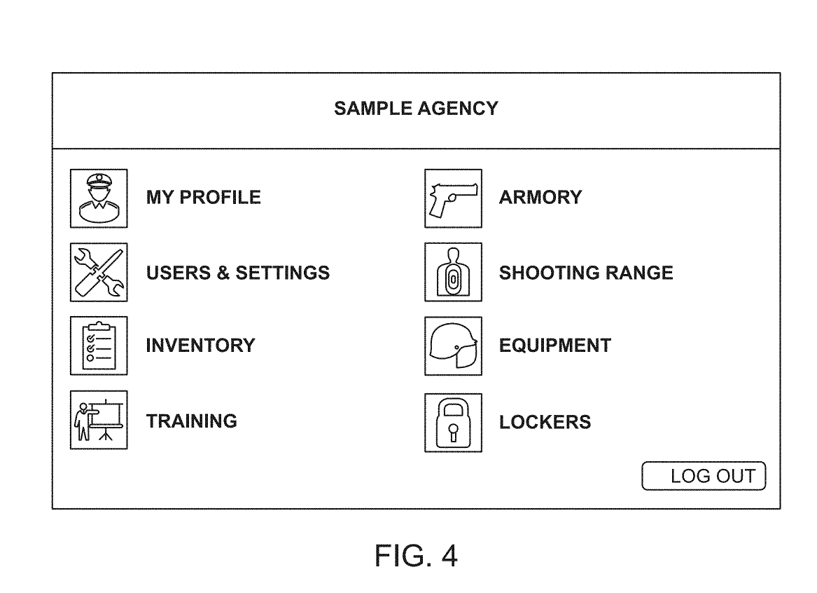

At step 130, subject to the permissions granted to a particular user, the management of assets associated with a law enforcement agency may be performed from a user device 30 using graphical user interfaces (GUIs) like the exemplary GUIs illustrated below in FIGS. 4 through 10. The law enforcement agency assets managed via GUIs consistent with embodiments of the present invention may include inventory, training activities, armory, shooting range activities, firearms or other equipment, or storage lockers 80. In various embodiments, these assets may be managed by the back-end server 50 via one or more software modules (e.g., application program interface (API), etc.) executed by one or more processors and/or one or more hardware modules (e.g., physical components) of the back-end server 50, such as application specific integrated circuits (ASICs) or other types of programmable hardware such as gate arrays. In various embodiments, these modules and GUIs may reside on the back-end server 50.

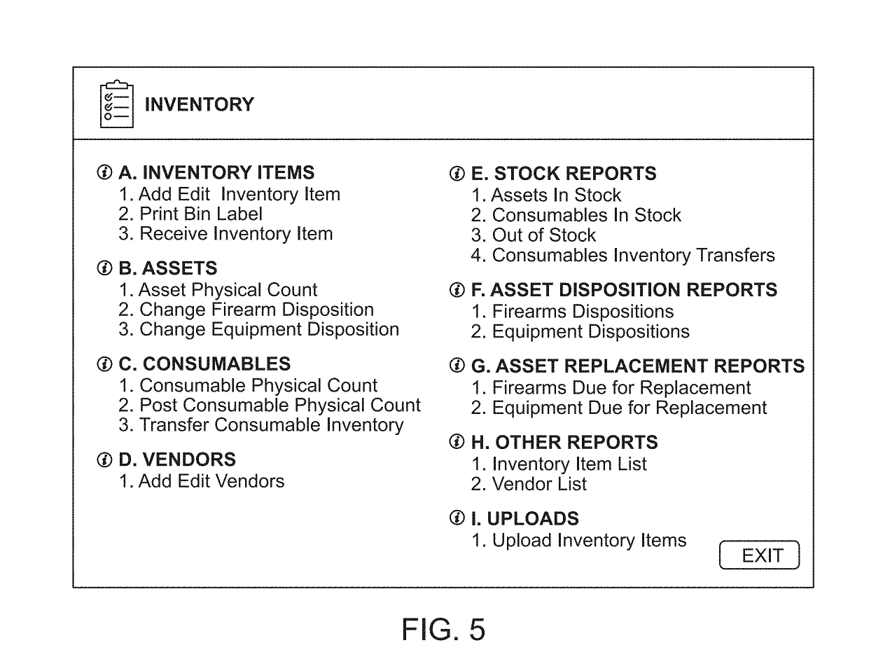

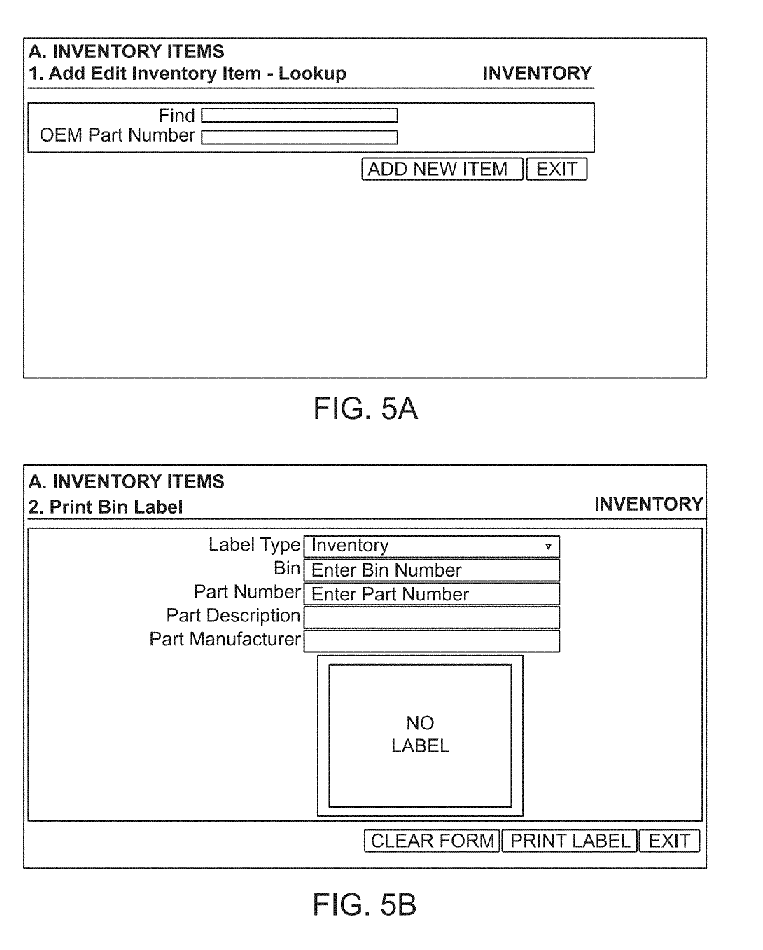

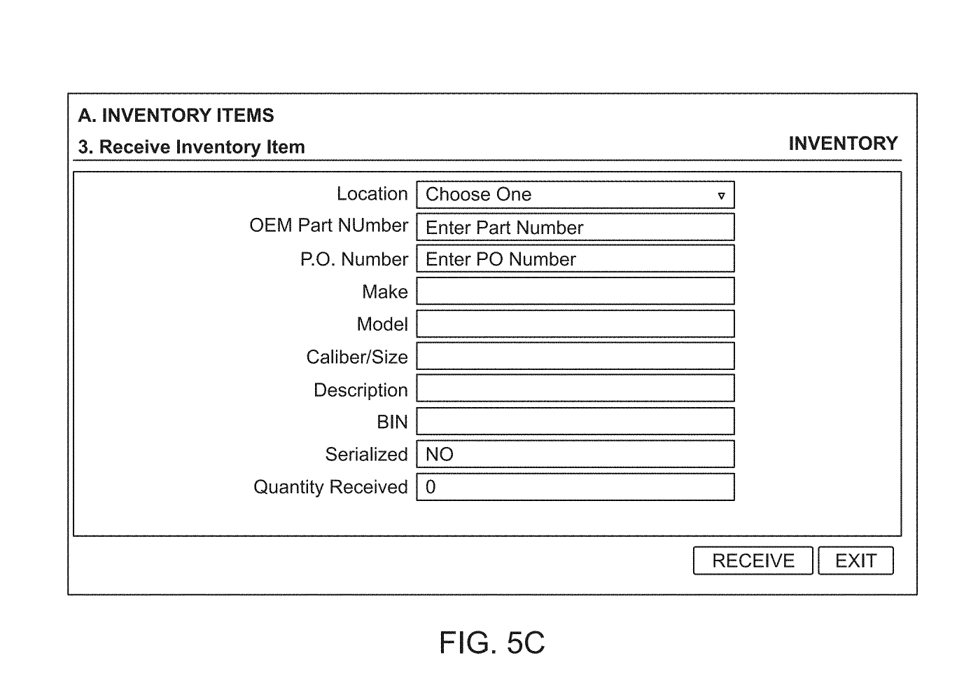

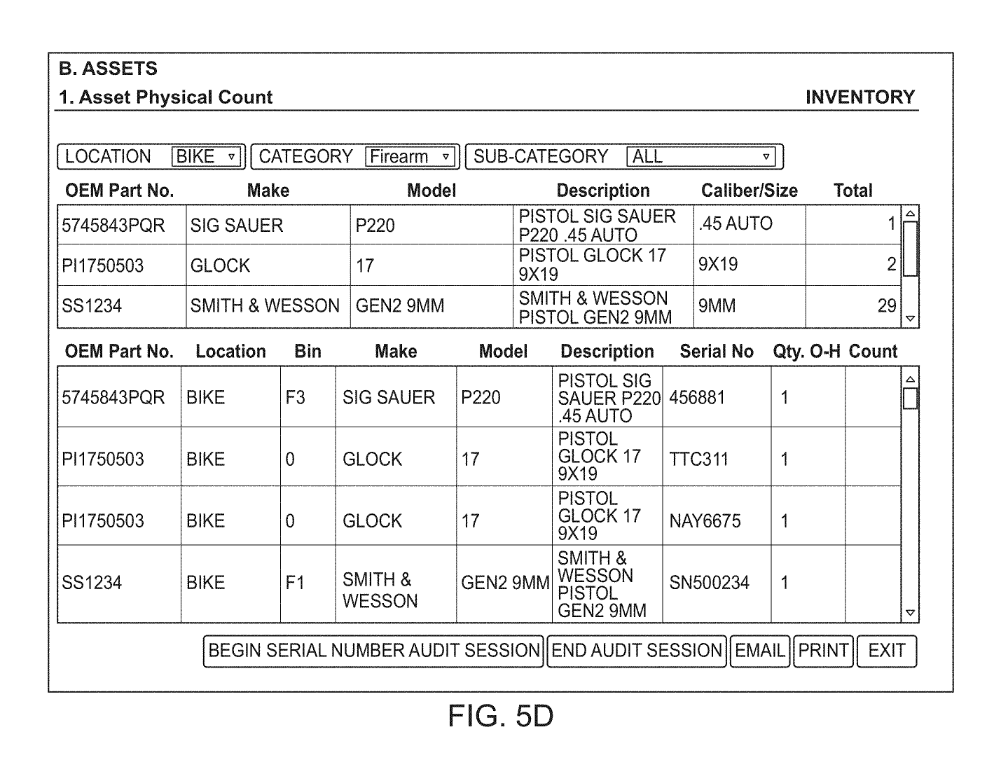

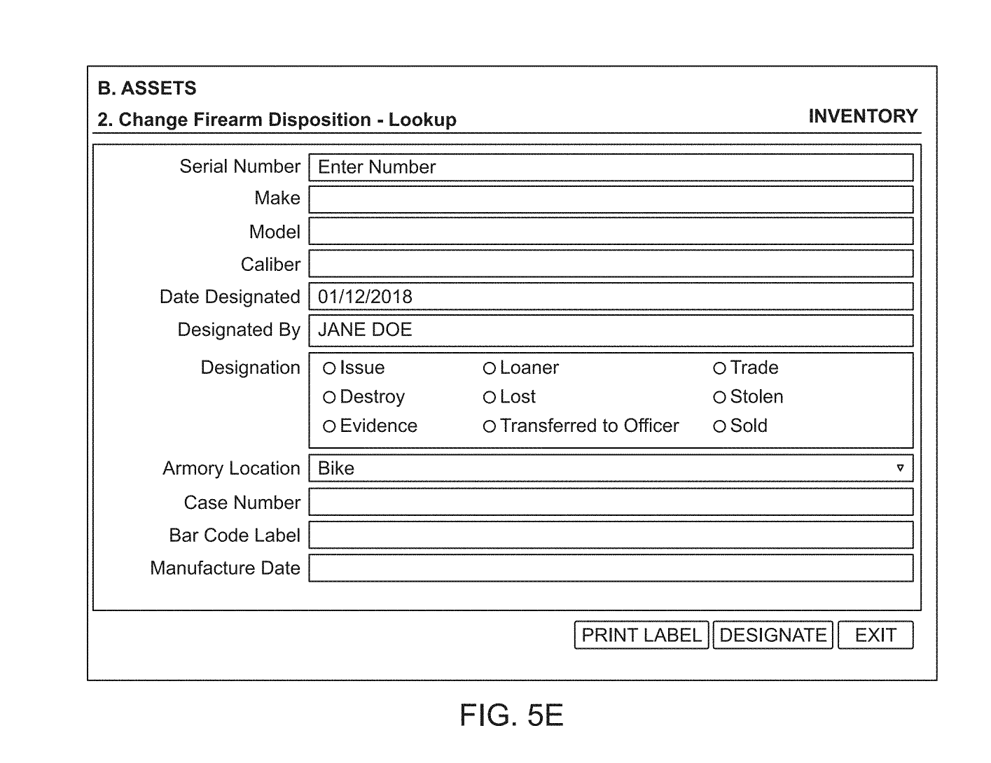

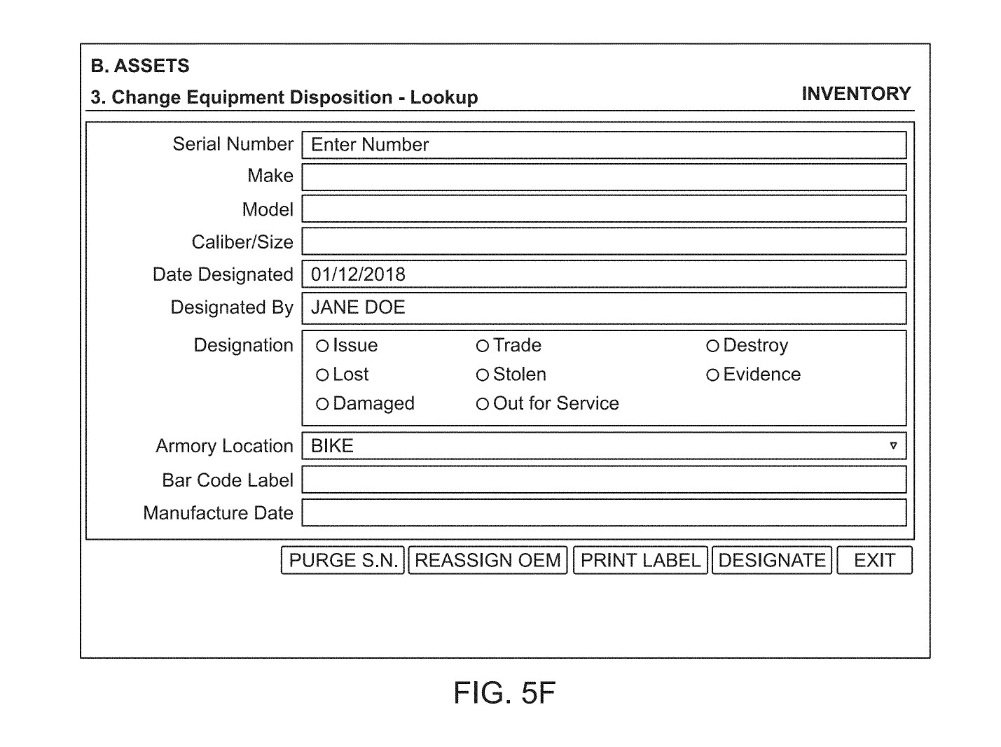

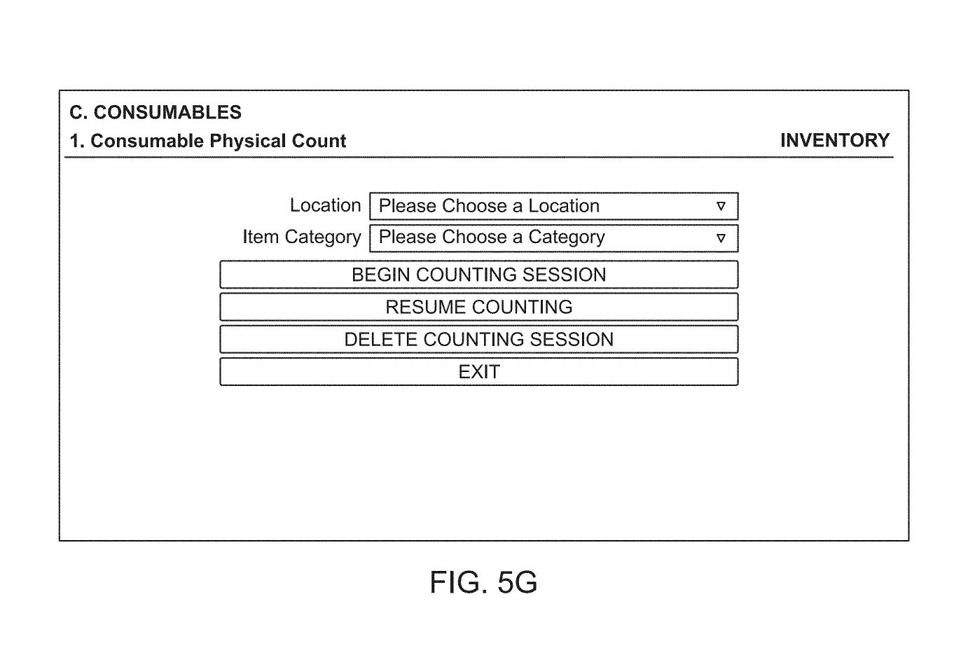

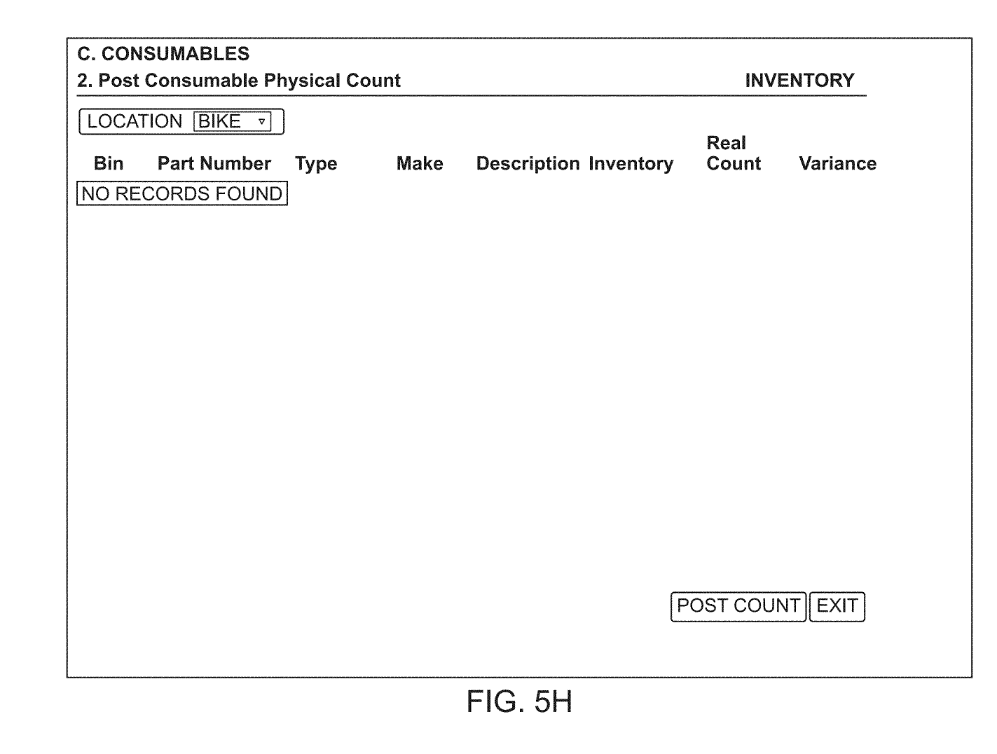

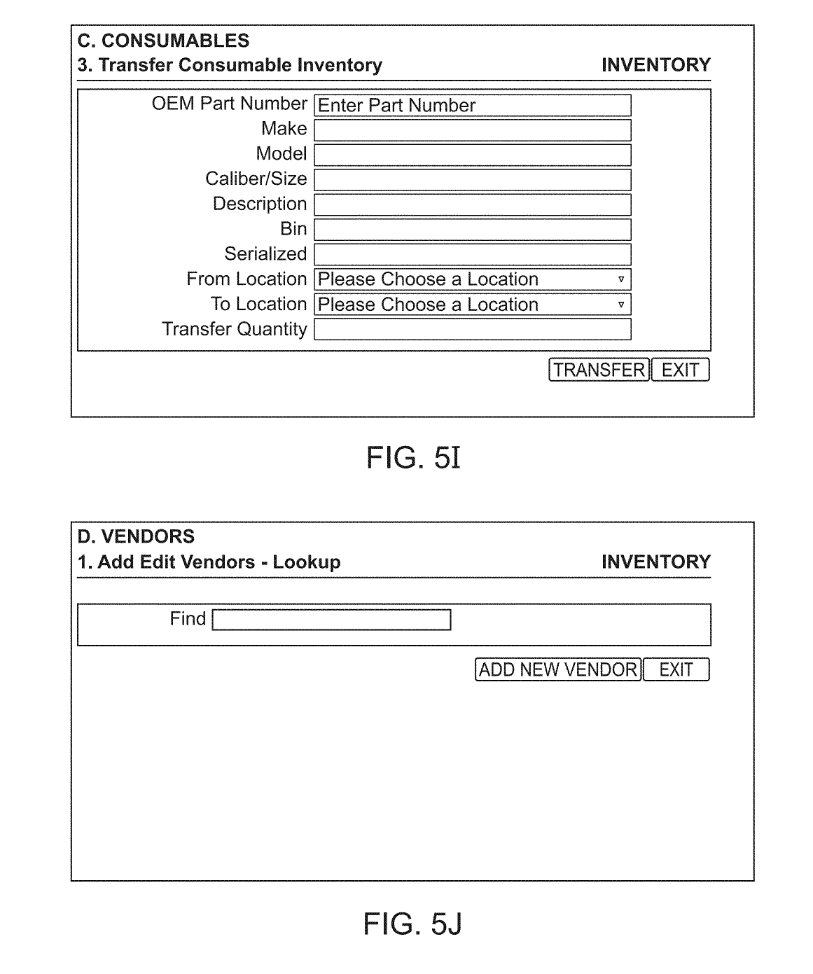

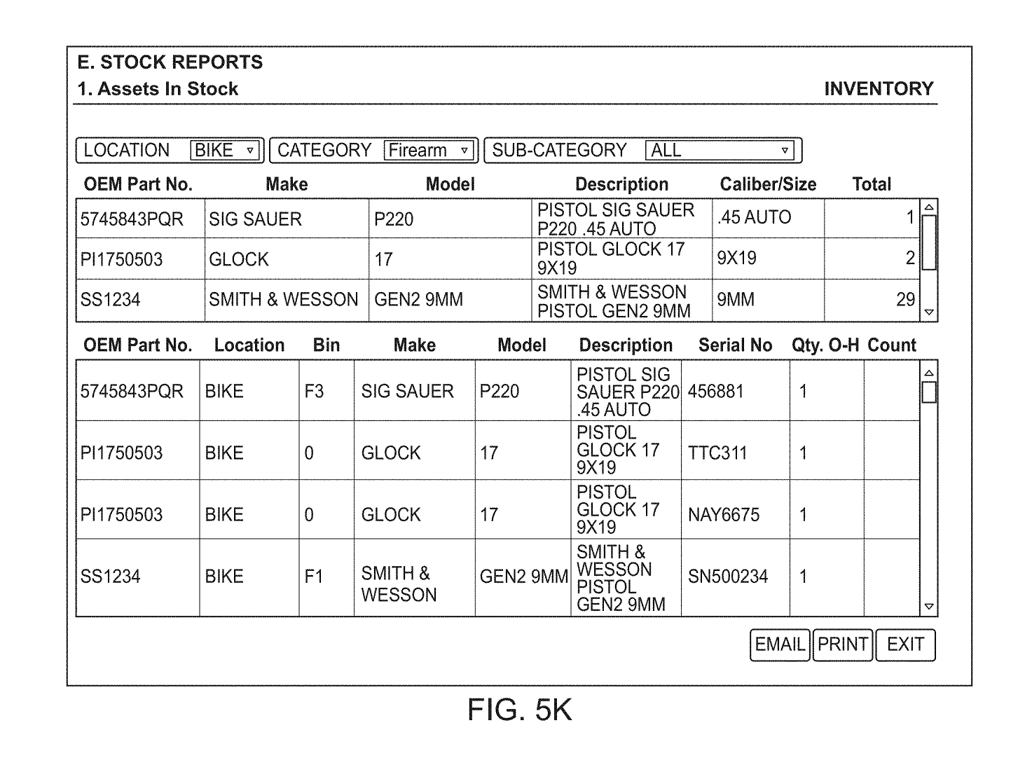

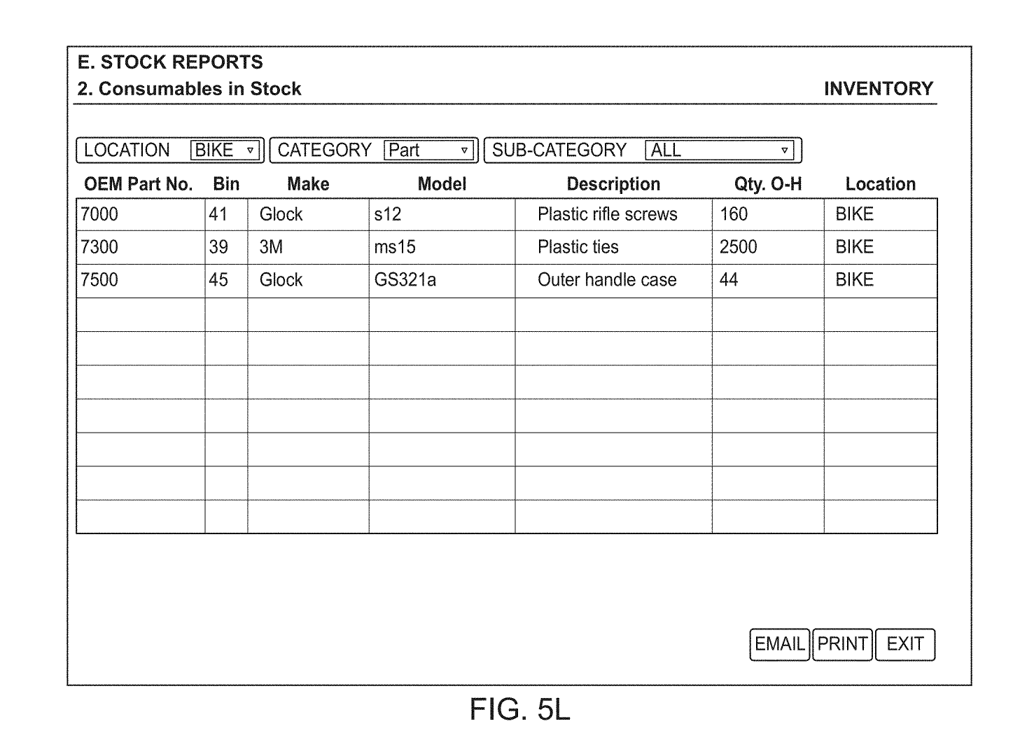

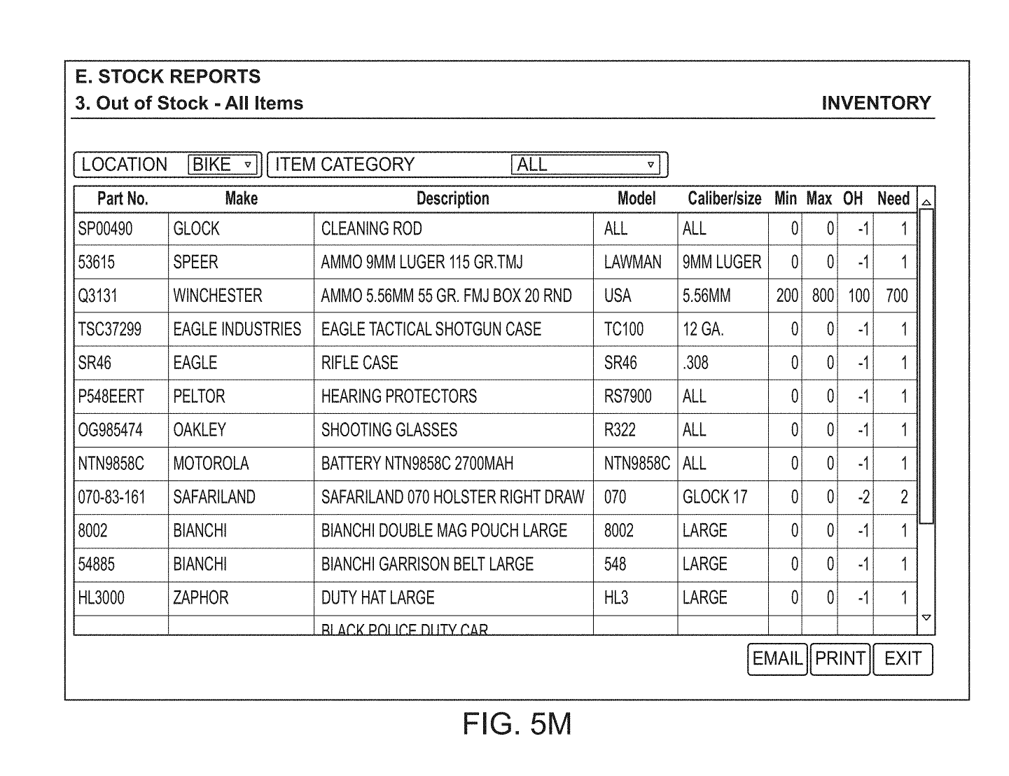

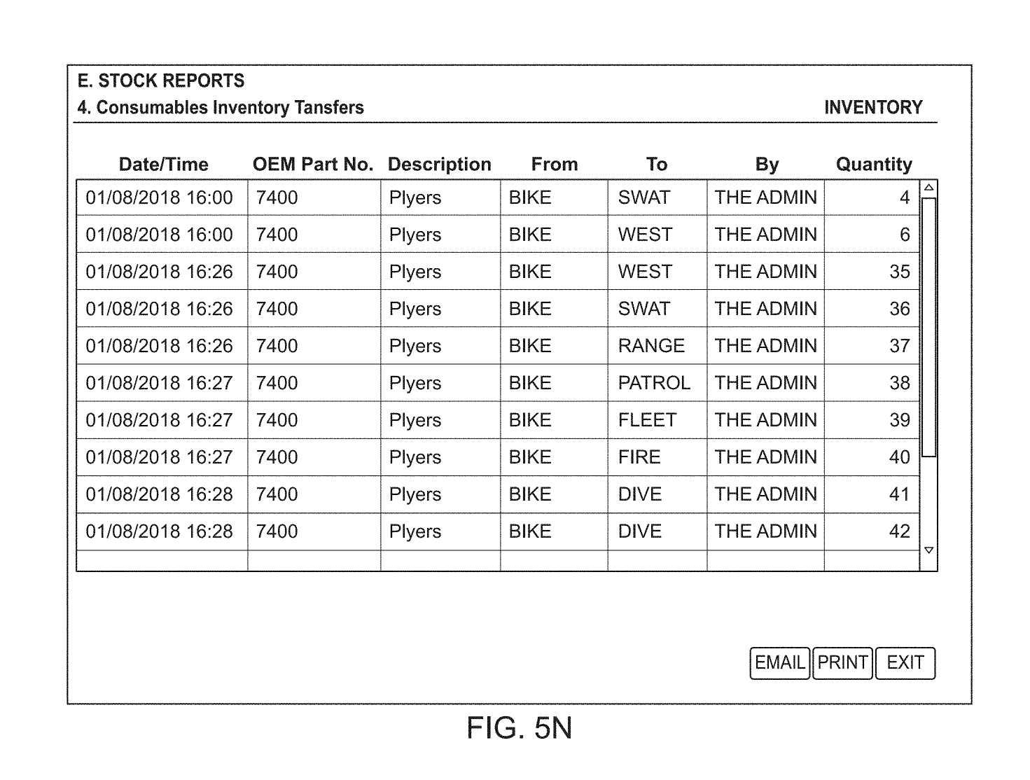

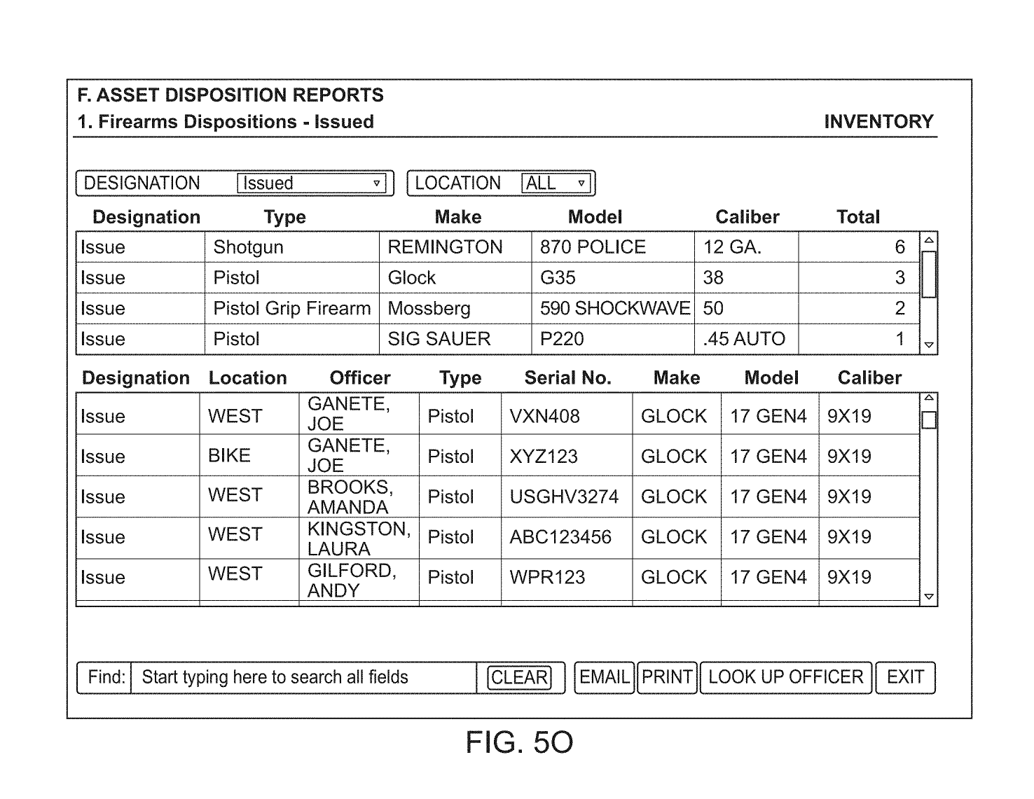

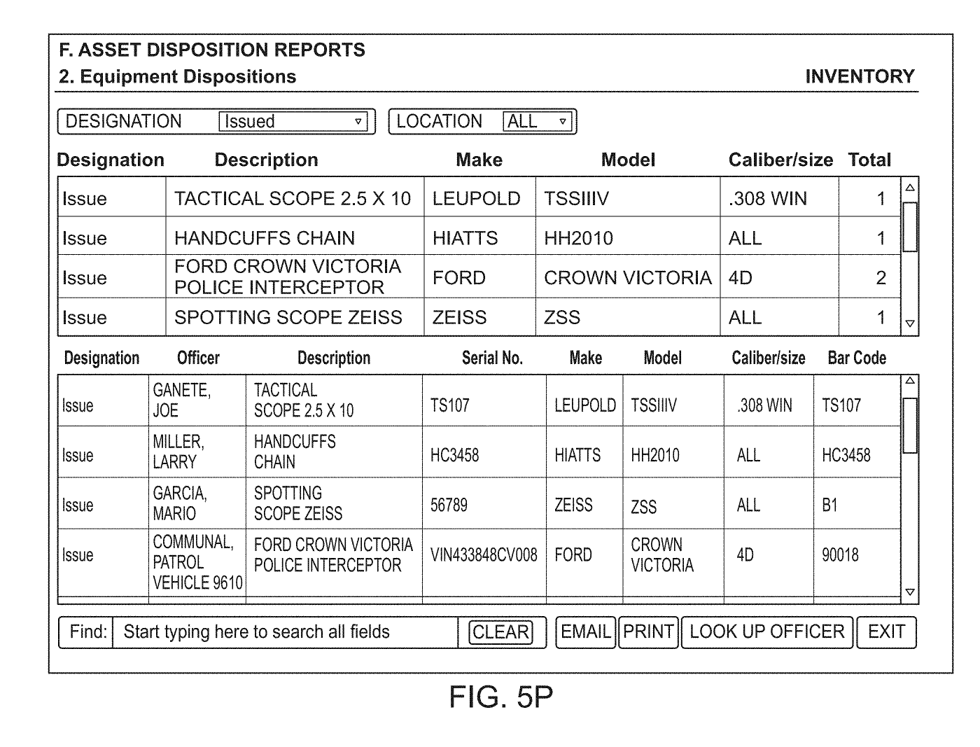

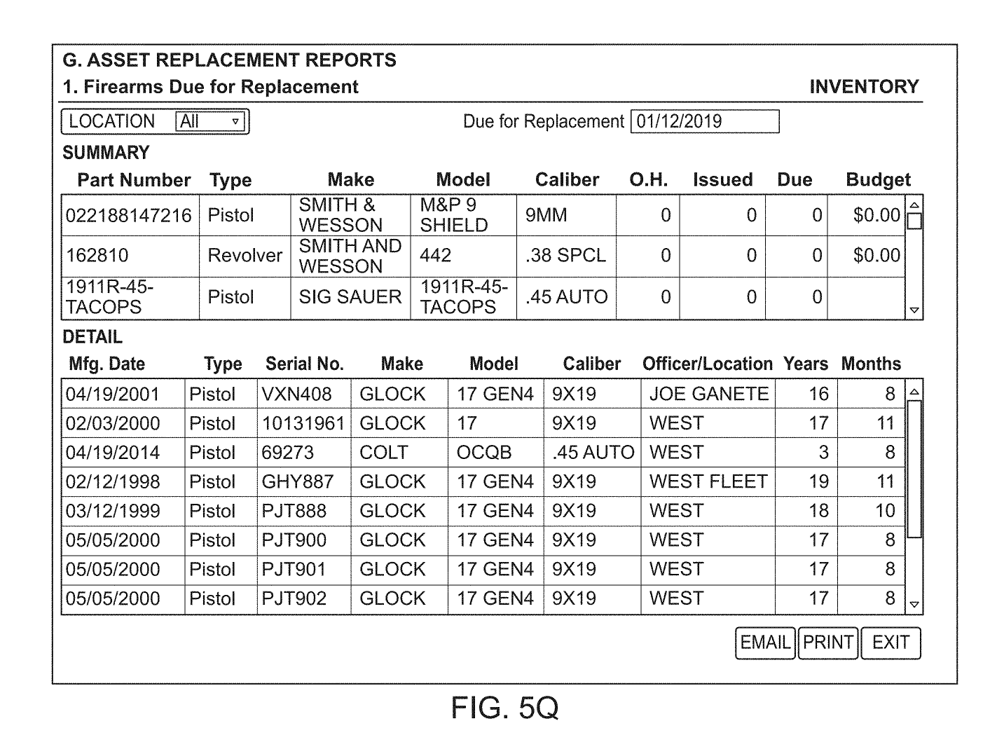

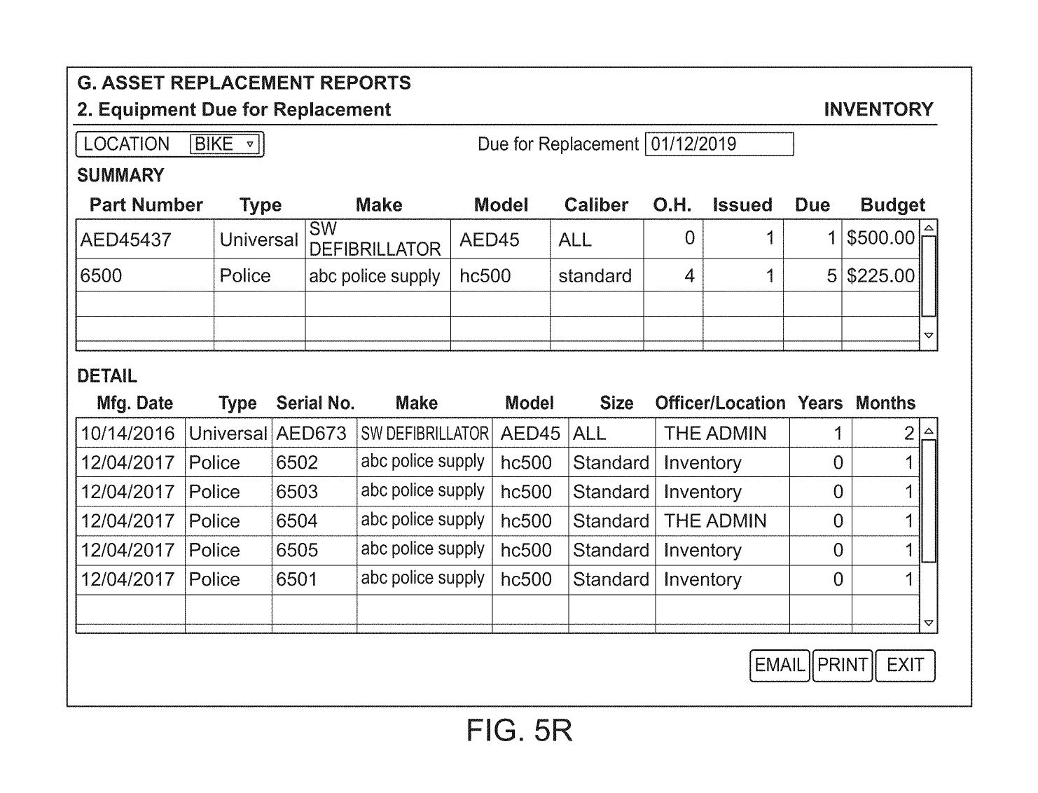

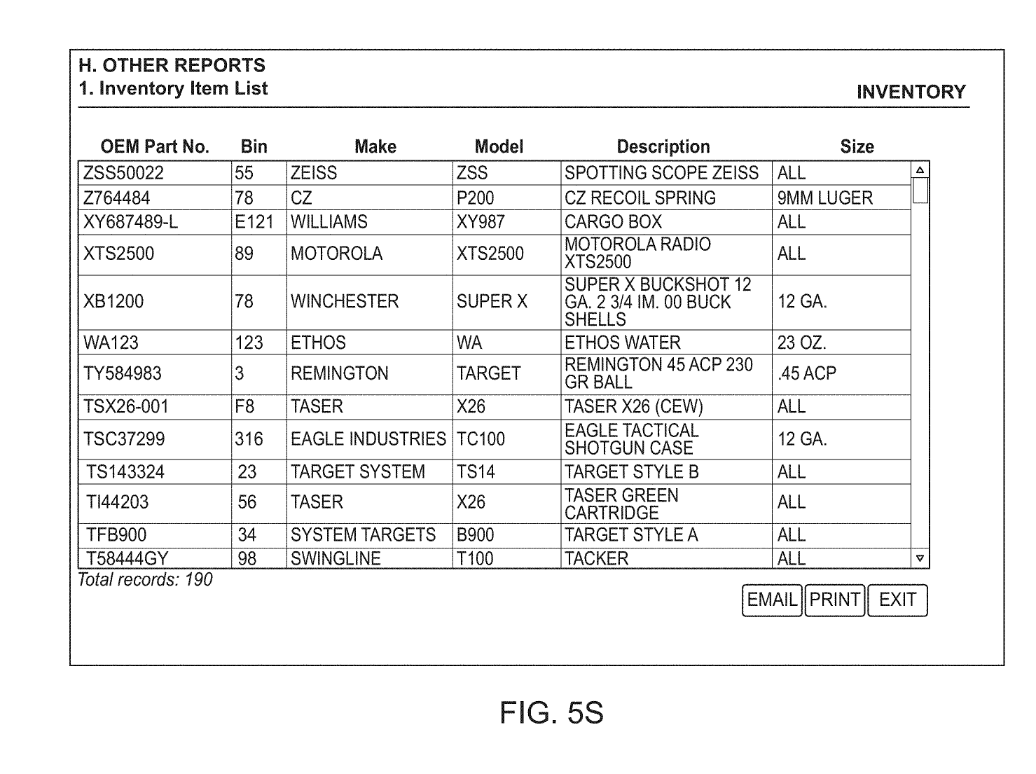

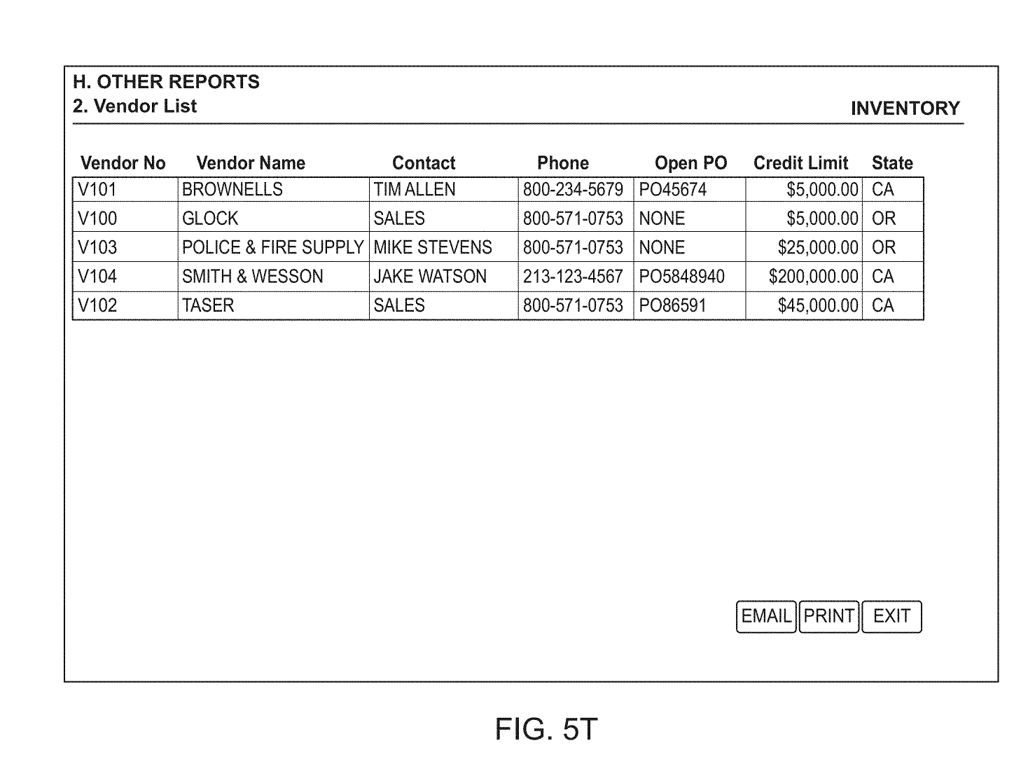

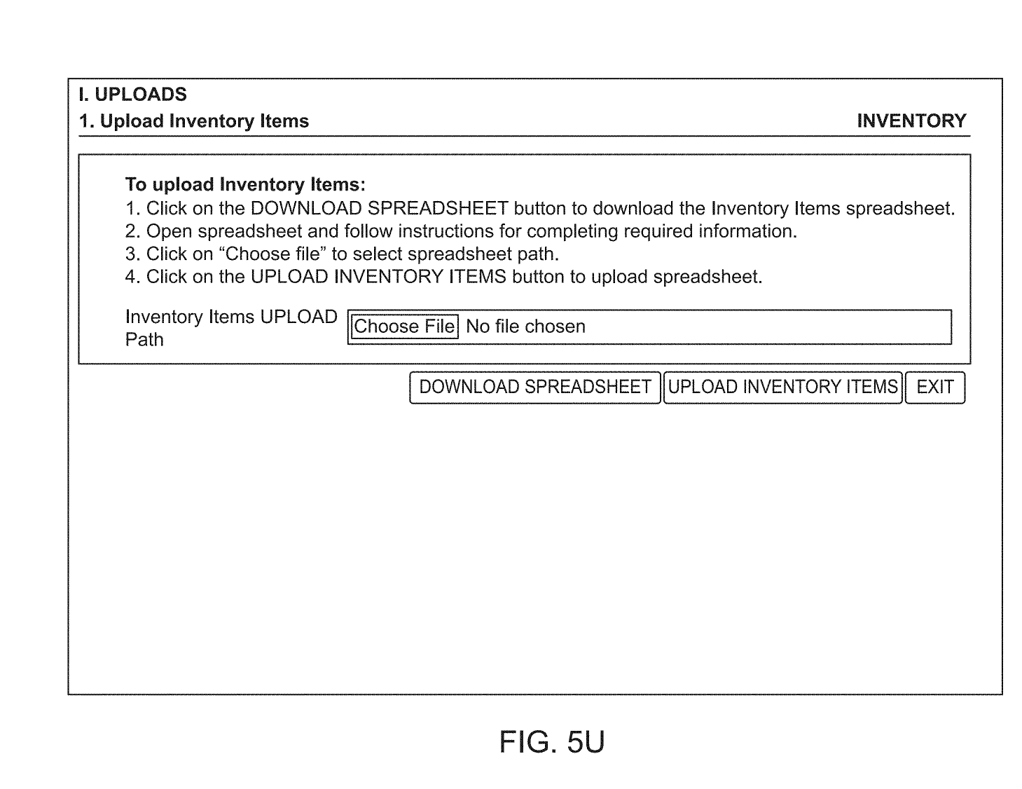

FIG. 4 is an exemplary home screen view that illustrates the primary functions of an asset management system 10 consistent with embodiments of the present disclosure. As illustrated in FIG. 4, and further described with reference to FIGS. 5 through 10, an asset management system 10 may include, among other things, functions for managing the law enforcement agency inventory, training activities, shooting range activities, armory, firearms and/or other equipment, and/or storage lockers 80.

FIG. 5 is an exemplary screen view that illustrates inventory management functions of an asset management system 10 consistent with embodiments of the present disclosure. These functions may include searching for an item in an inventory by part number and/or adding a new item to an inventory (FIG. 5A), printing label(s) for inventoried item(s) (FIG. 5B), and/or receiving an item into inventory (FIG. 5C). Inventory management functions consistent with embodiments of the present disclosure may also include maintaining the number of items currently in inventory by location, item type or subtype, part number, make, model, description, and/or caliber/size (FIG. 5D); reviewing and/or changing the assignment of a firearm, including assignments from one officer to another, from an officer to inventory or vice-versa, and the like (FIG. 5E); reviewing and/or changing the assignment of equipment other than firearms, including assignments from one officer to another, from an officer to inventory or vice-versa, and the like (FIG. 5F); providing a physical count of consumable inventory (i.e., items that may be associated with a serial number and have no disposition status) by location and category at any moment in time to facilitate, among other things, identifying inventory shrinkage as a result of waste, theft, or the like (FIG. 5G); adjusting inventory balances based on physical inventory audits (FIG. 5H); and transferring inventory from one location to another, including transferring inventory to a storage locker (FIG. 5I).

Other inventory management functions consistent with embodiments of the present disclosure may include adding new vendors and/or searching for information about existing vendors (FIG. 5J). Still other inventory management functions consistent with embodiments of the present disclosure may include generating stock reports that reflect the number and type of currently inventoried assets (i.e., items associated with a serial number, service life, and disposition status (e.g., in-service, issued, transferred, damaged, stolen, decommissioned status, etc.)) (FIG. 5K); generating stock reports that reflect the number and type of consumables currently in inventory (i.e., items that may be associated with a serial number and have no disposition status) (FIG. 5L); generating stock reports for inventory deficiencies (e.g., items out of stock and/or under stocked) (FIG. 5M); and generating reports for consumables in inventory (i.e., items that may be associated with a serial number and have no disposition status) that have been transferred from one location to another) (FIG. 5N).

Inventory management functions consistent with embodiments of the present disclosure may further include generating information about issued firearms, including the number of issued firearms, and the make, model, serial number, and caliber associated with the firearm, and to whom the firearm is issued (FIG. 5O); and generating information about issued equipment (i.e., equipment other than firearms), including the number of issued equipment and the make, model, serial number, caliber associated with the equipment, and/or to whom the equipment is issued (FIG. 5P).

Inventory management functions consistent with embodiments of the present disclosure may also include generating information about firearms that are due for replacement (FIG. 5A), and generating information about equipment (other than firearms) that are due for replacement (FIG. 5R). Still other inventory management functions consistent with embodiments of the present disclosure may include generating lists of all inventoried items, including firearms and equipment (FIG. 5S); generating and maintaining vendor lists, including vendor contact information and credit limits (FIG. 5T); and uploading inventory items from an external file (FIG. 5U).

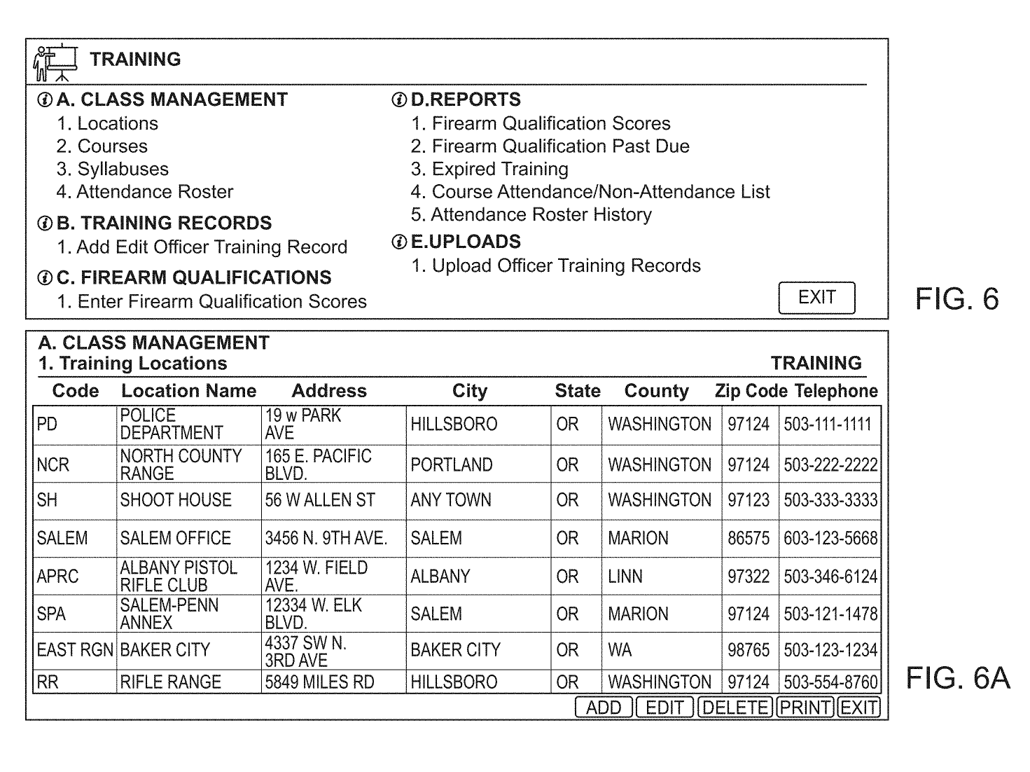

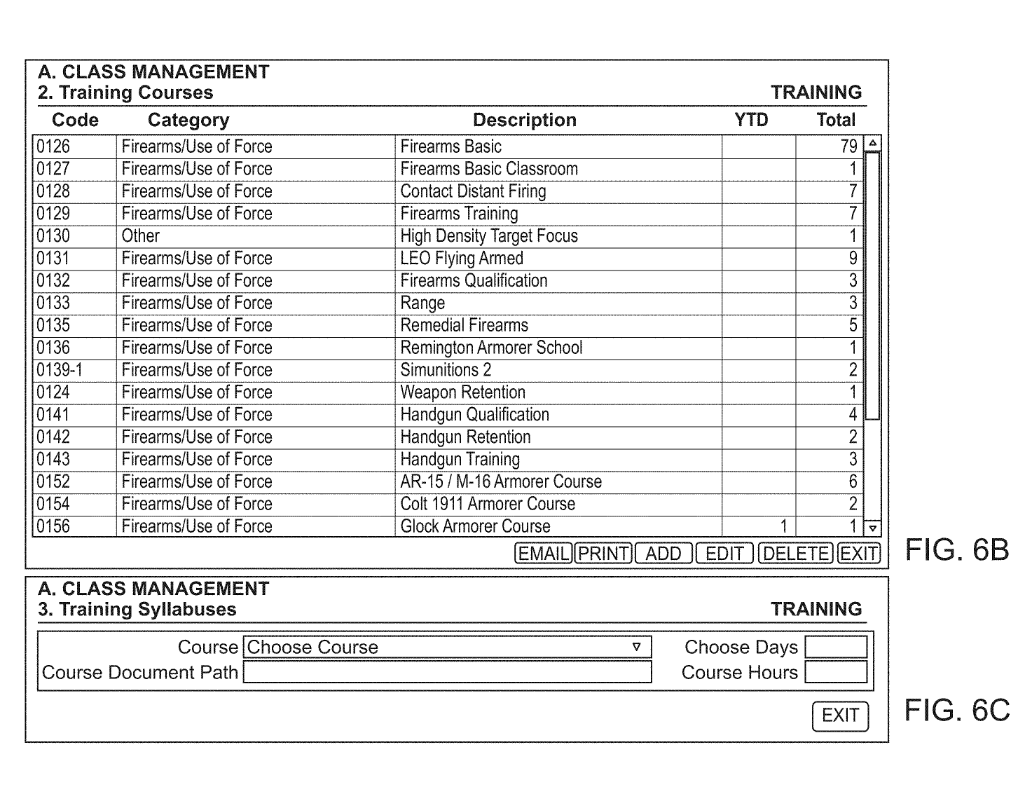

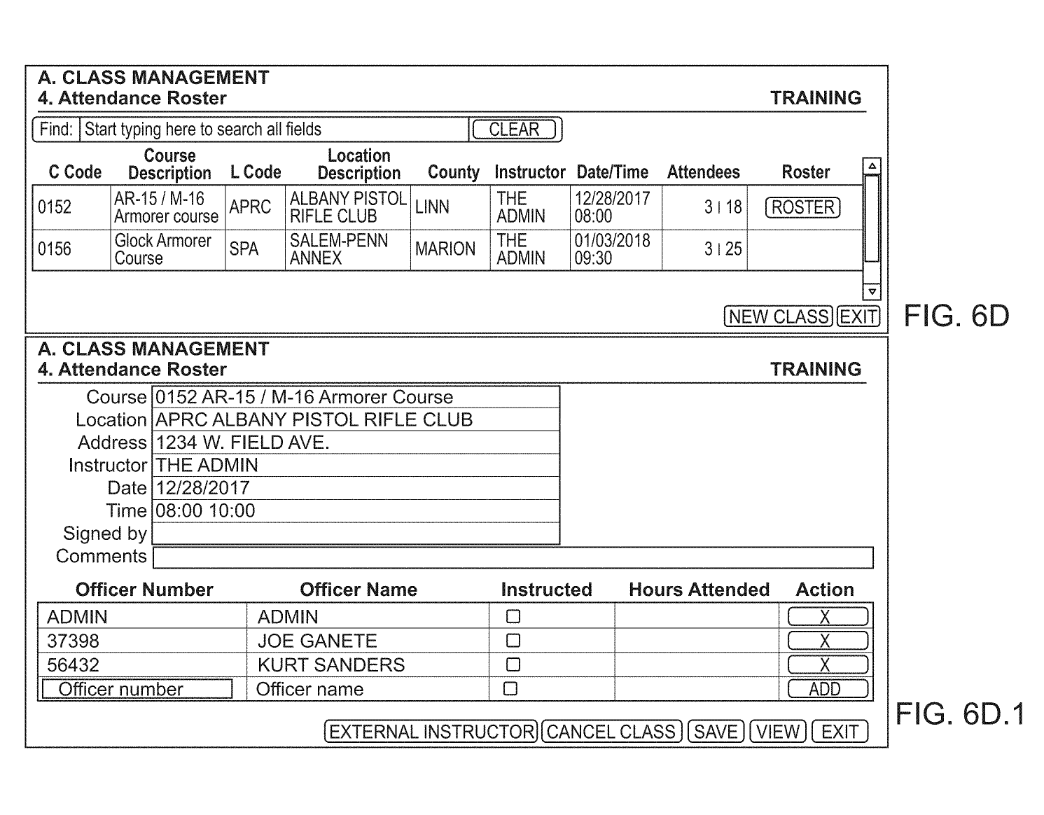

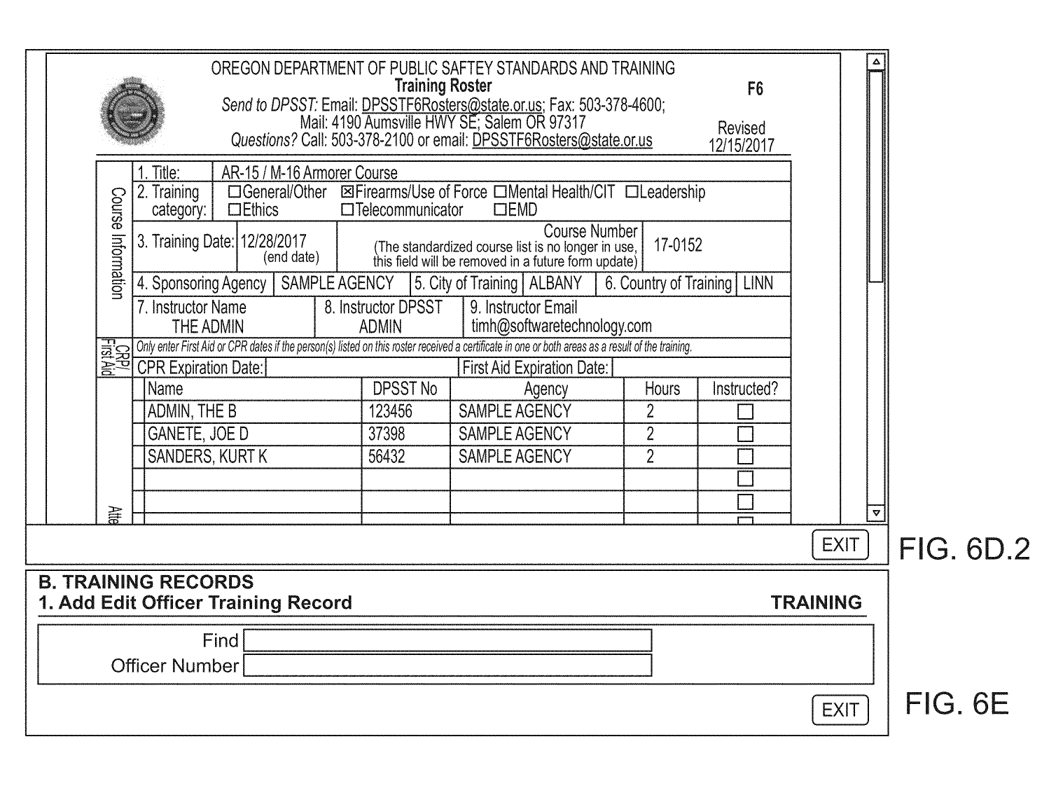

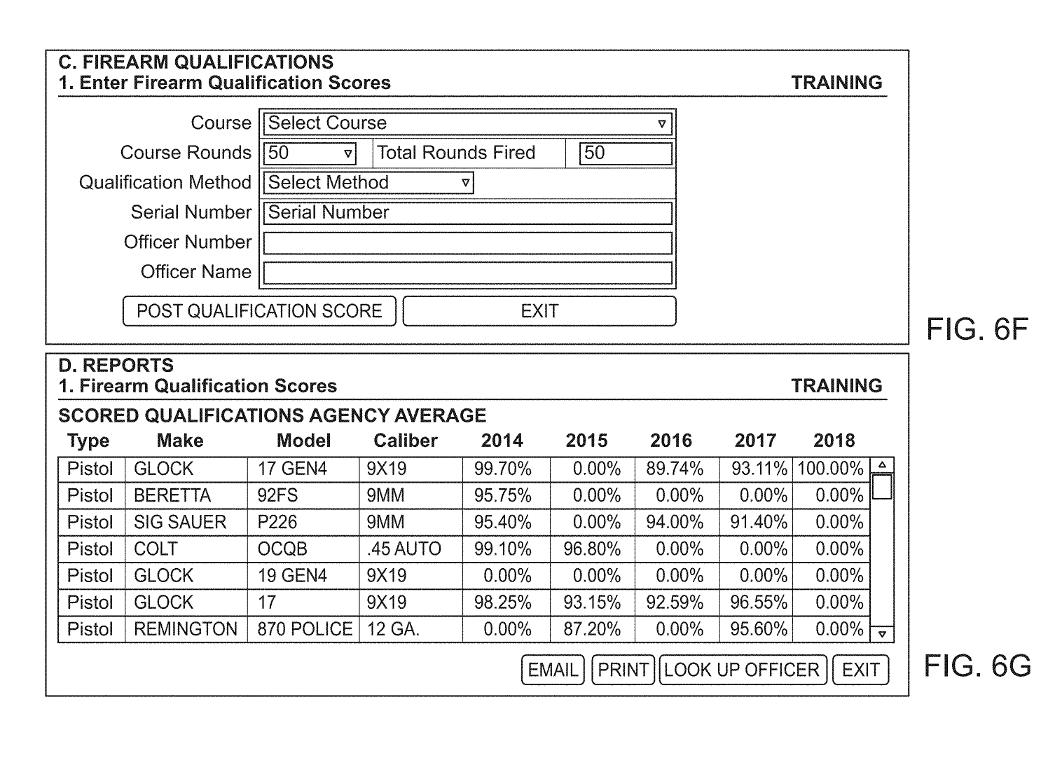

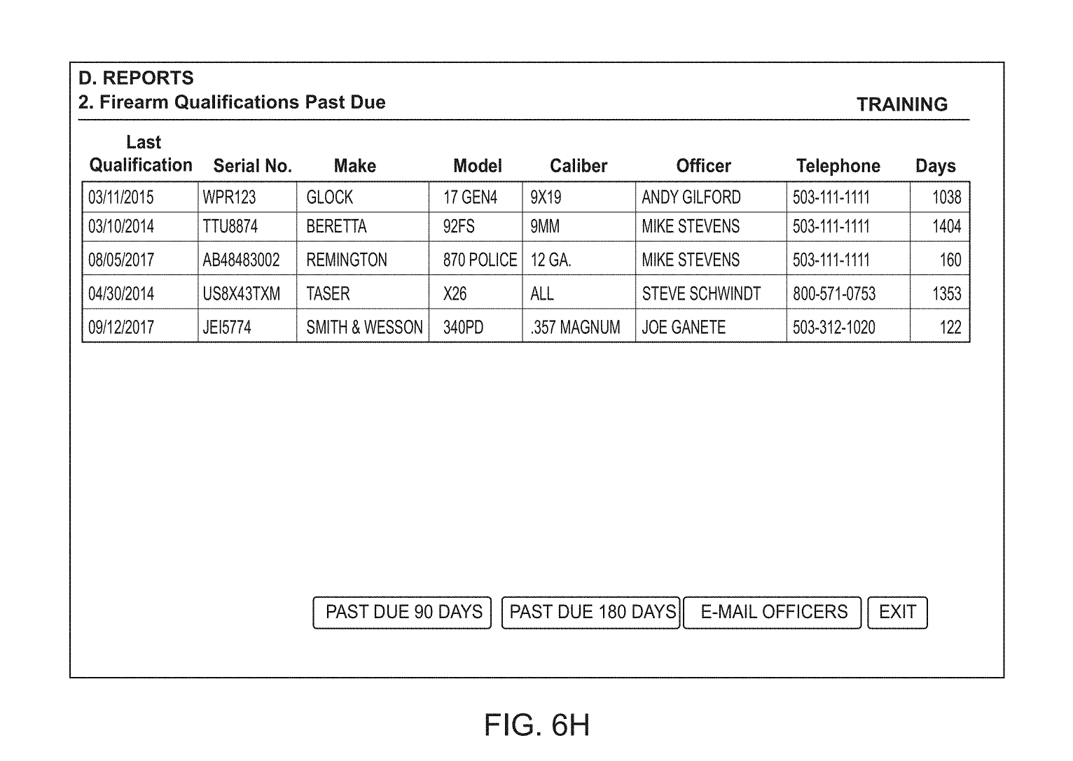

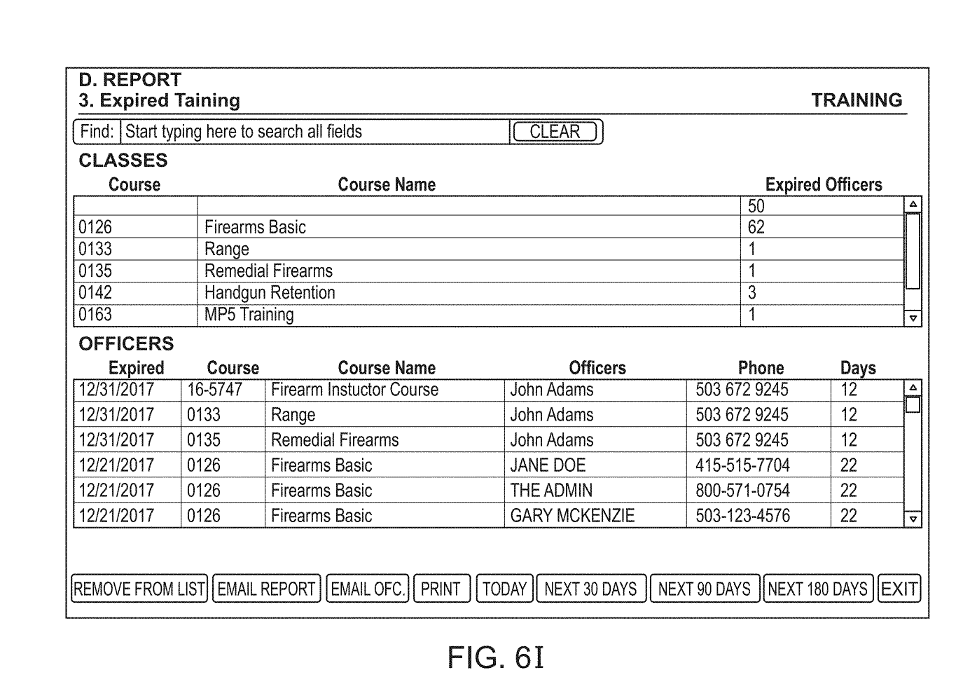

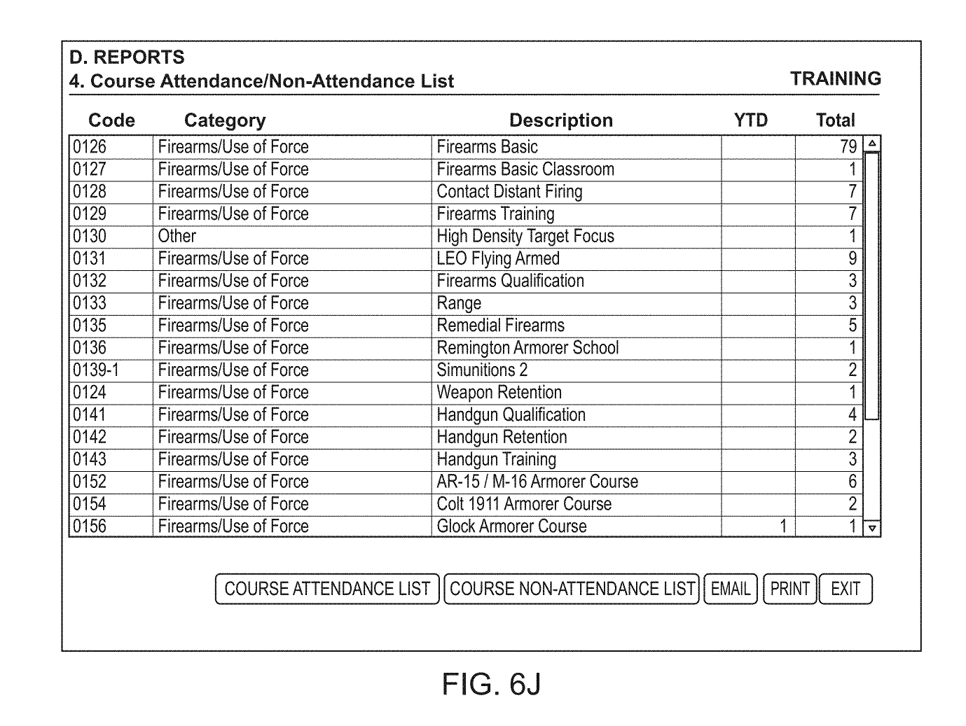

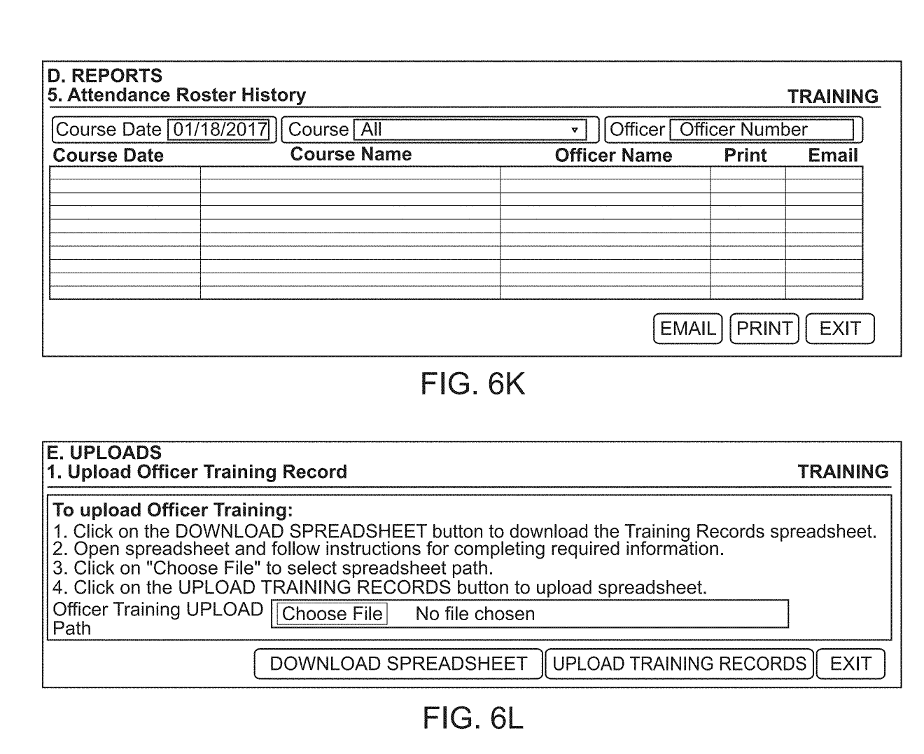

FIG. 6 is an exemplary screen view that illustrates functions for managing the training activities of a law enforcement agency consistent with embodiments of the present disclosure. These functions may include maintaining the locations of (and other information associated with) training facilities (FIG. 6A); maintaining information about available training courses (FIG. 6B); maintaining study materials and time requirements associated with a particular course (FIG. 6C); and maintaining attendance information for a course, including the course location, instructor, number of attendees (FIG. 6D); maintaining information that identifies the officers who attended a particular course (FIG. 6D.1); and automatically populating state-mandated training roster forms associated with a particular course (FIG. 6D.2). Training management functions consistent with embodiments of the present disclosure may also include adding or editing an officer training record (FIG. 6E), and entering firearm qualification scores for a particular officer (FIG. 6F).

Training management functions consistent with embodiments of the present disclosure may further include generating reports associated with various training activities in a law enforcement agency. For example, generating a firearm qualification report that may show, in real time via a mobile app or other application, the number of rounds discharged from a firearm, and the percentage of rounds discharged that fall within a pre-determined agency threshold for shooting accuracy (FIG. 6G). Generating a report that may include information about whether an officer's firearm qualification testing is past due, including identifying the firearm for which the testing is past due by serial number, make, model, and caliber (FIG. 6H). Generating a report that may list expired training courses and any officer associated with the expired course (FIG. 6I). Generating a report that may include the total number of officers who have attended (or not attended) a particular course (FIG. 6J). Generating a report that may include attendance information about a particular training course, including the name of the course, the officer(s) who attended the course, and the date(s) of attendance (FIG. 6K). And uploading training records from an external file (FIG. 6L).

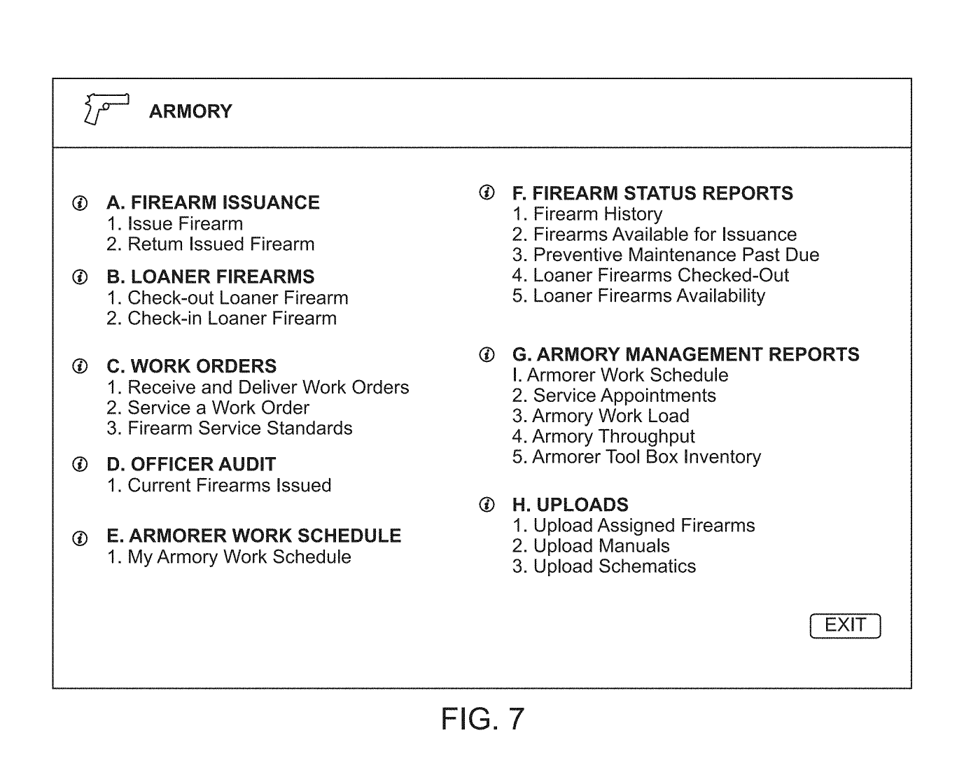

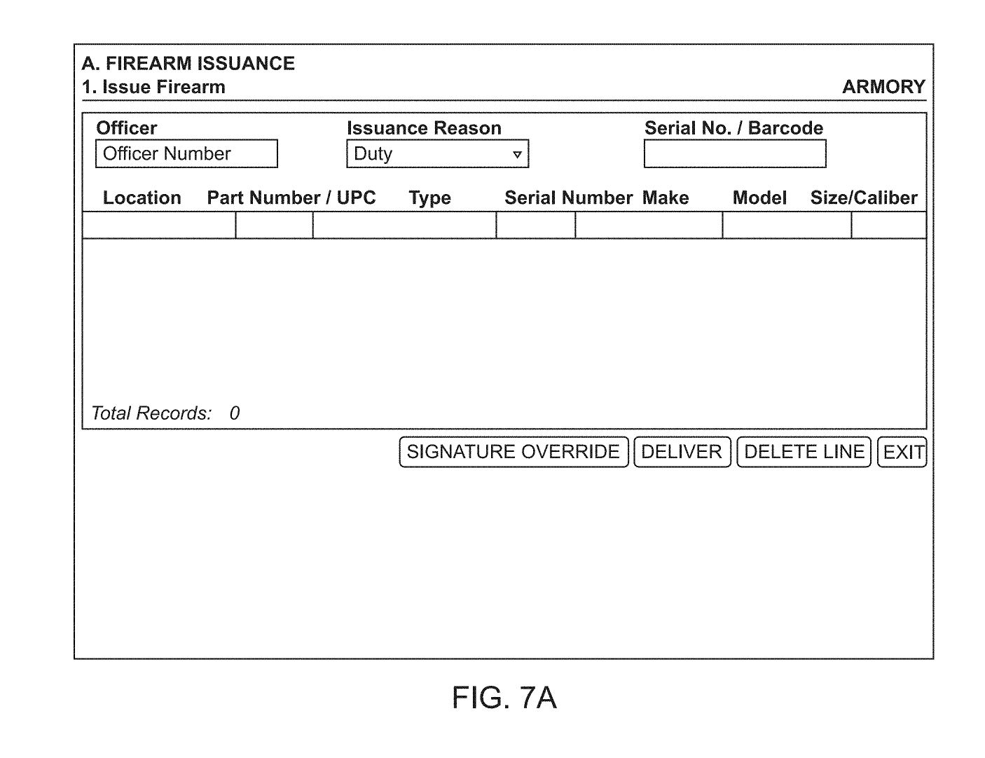

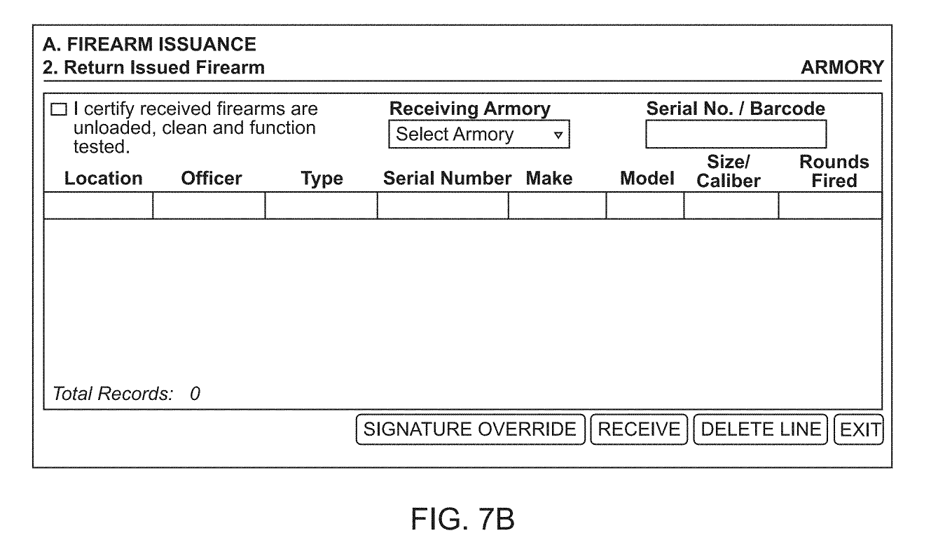

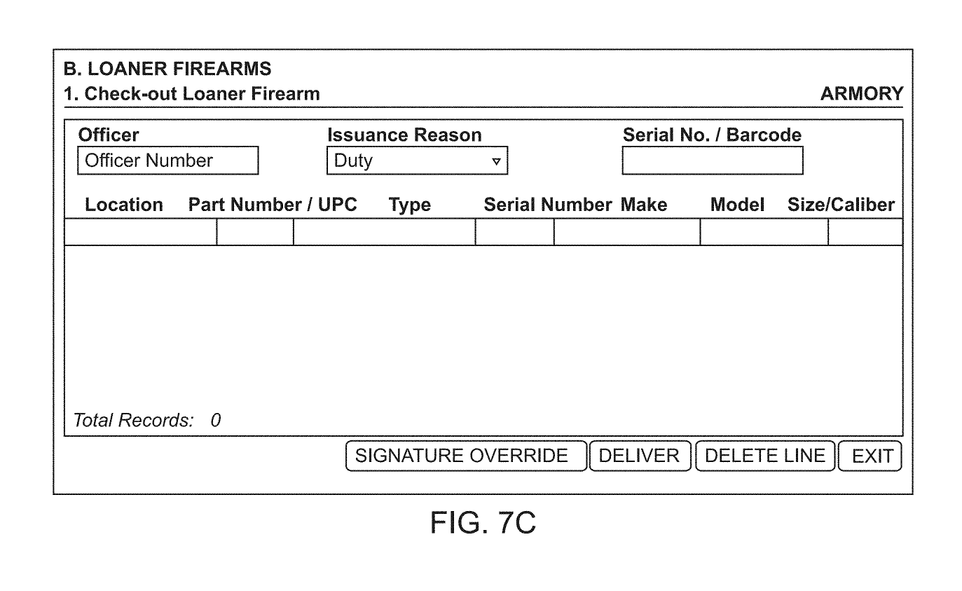

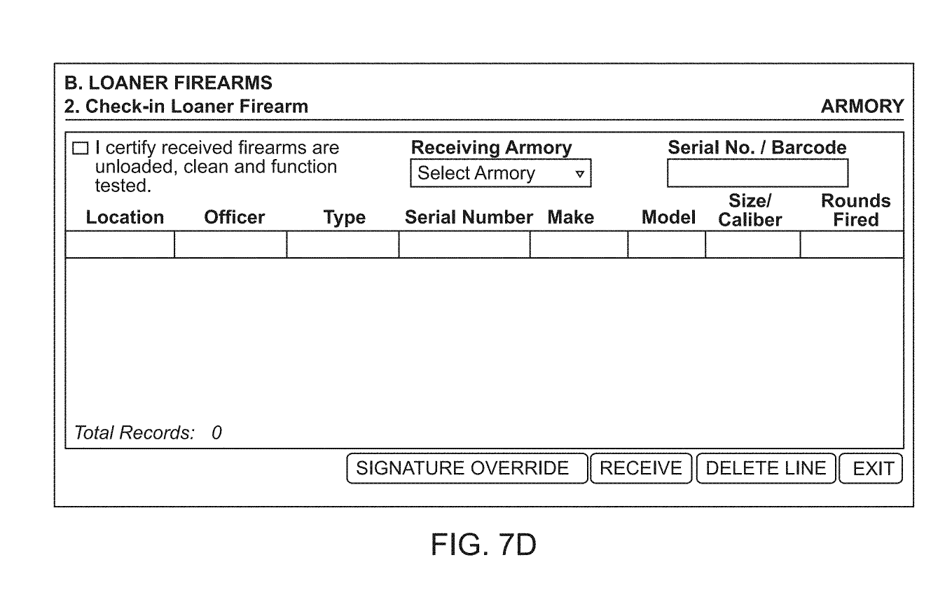

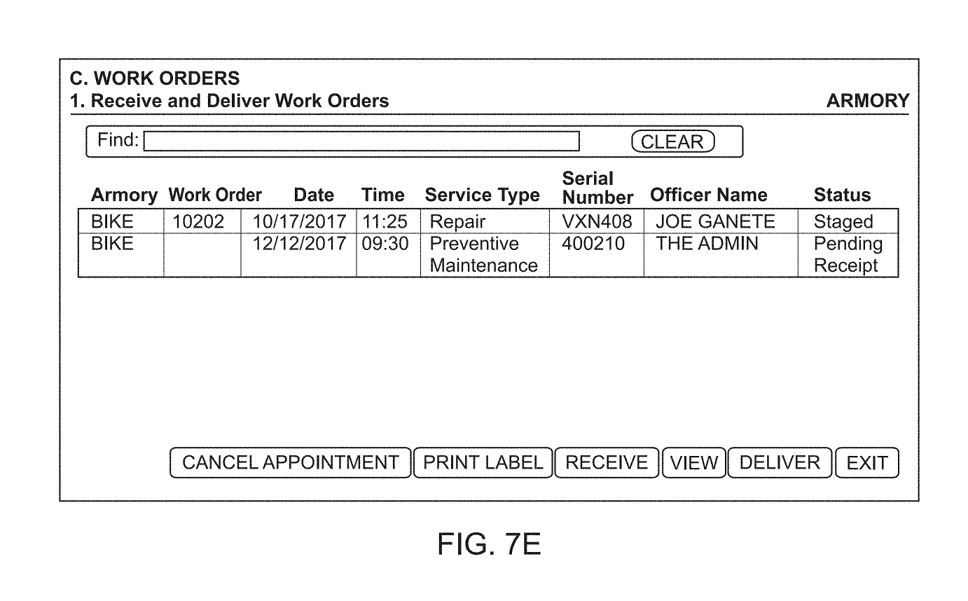

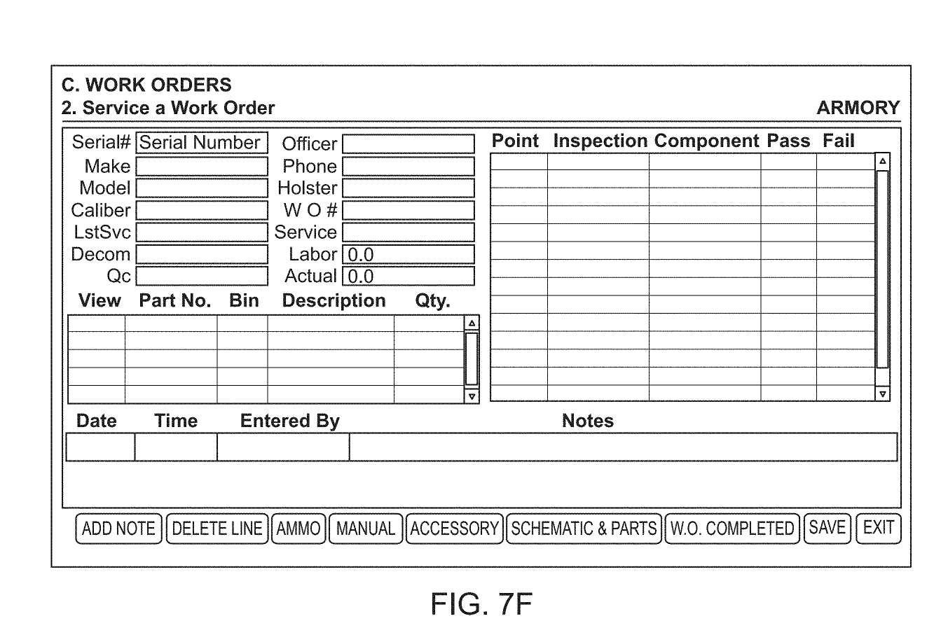

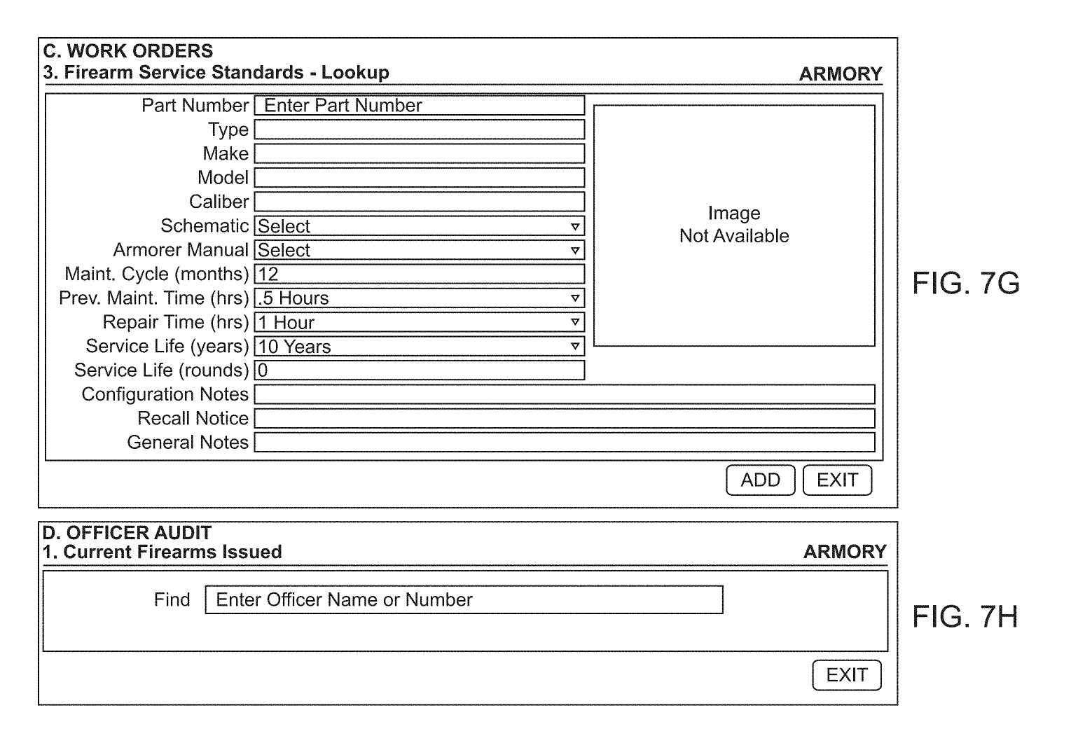

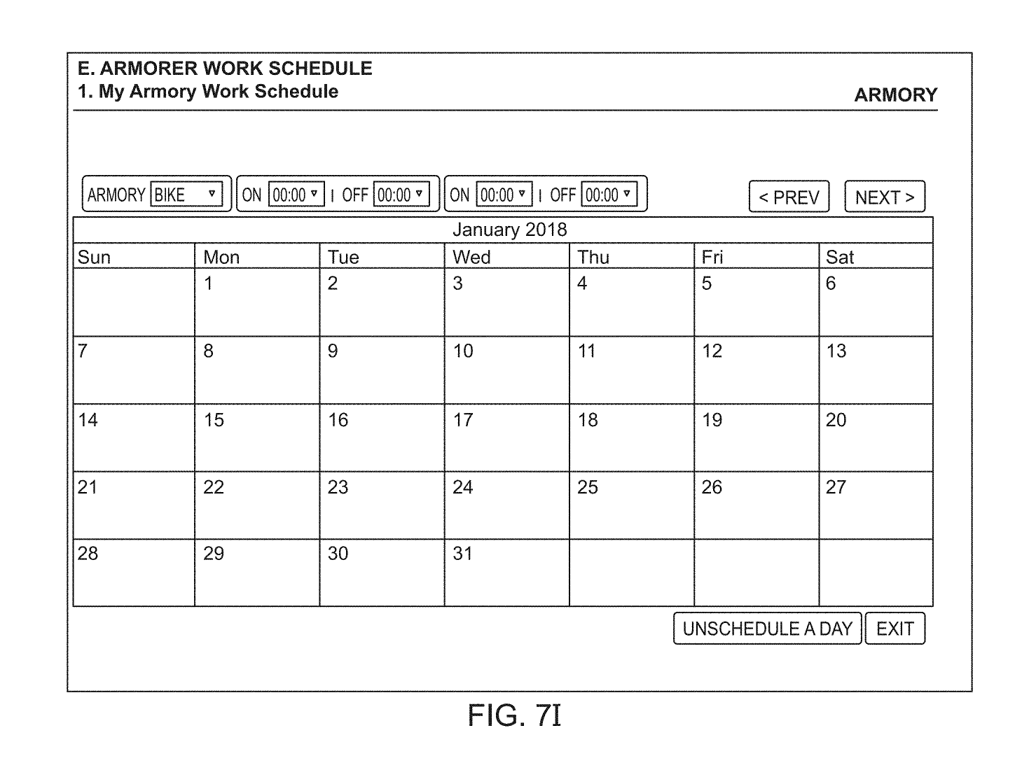

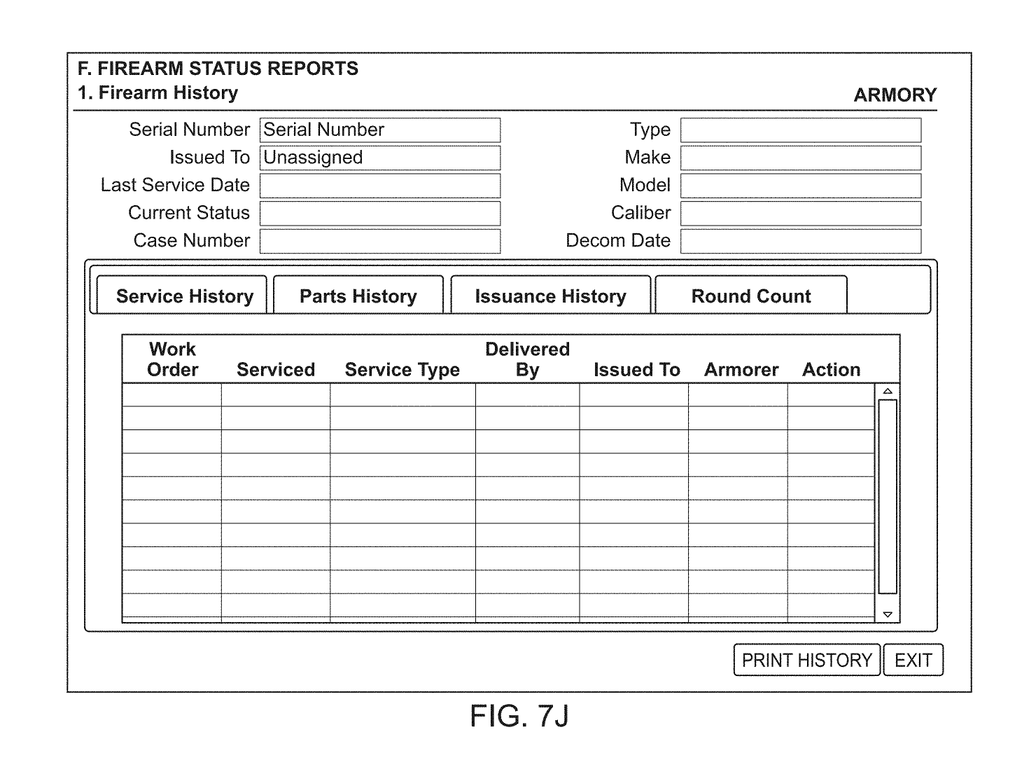

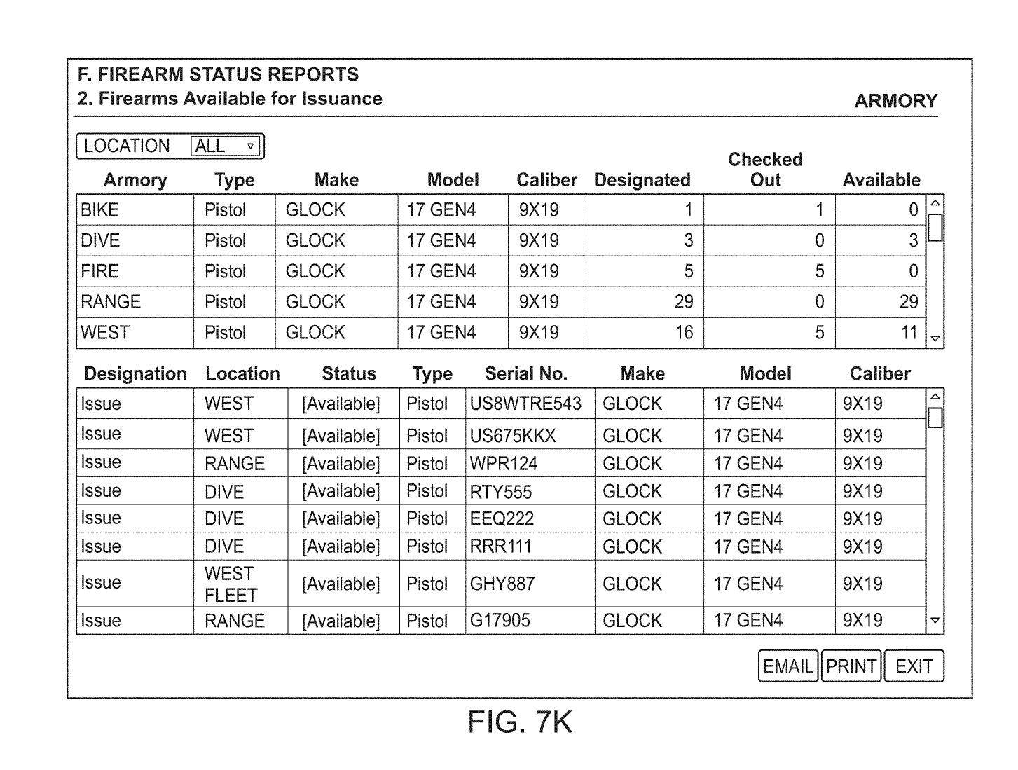

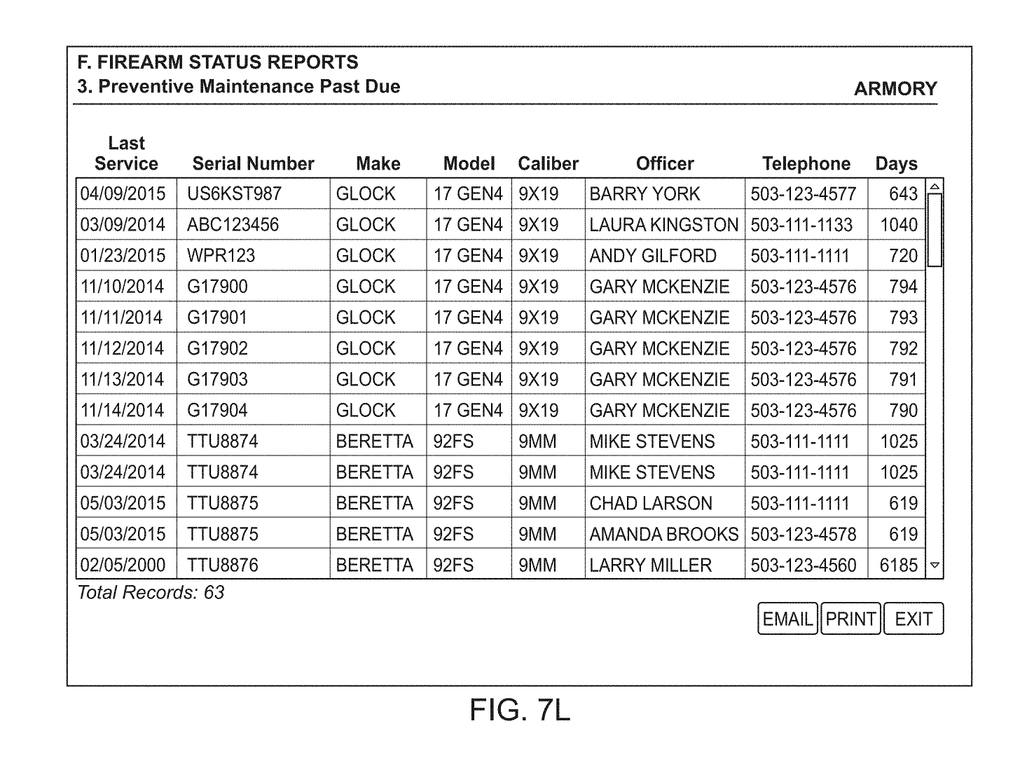

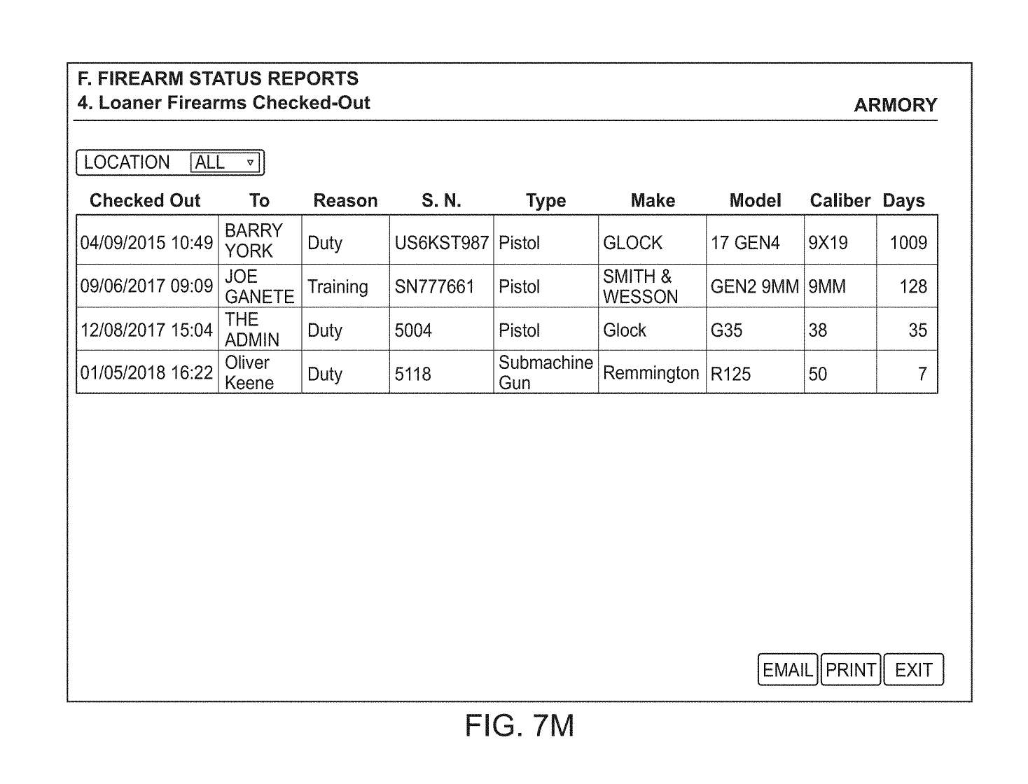

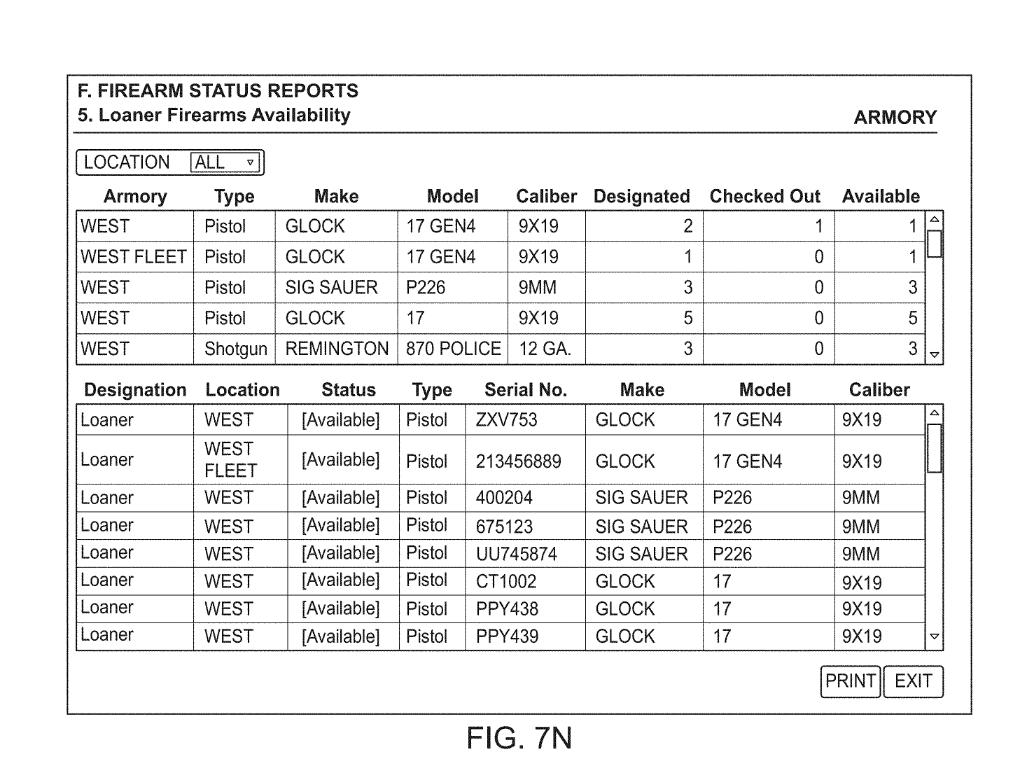

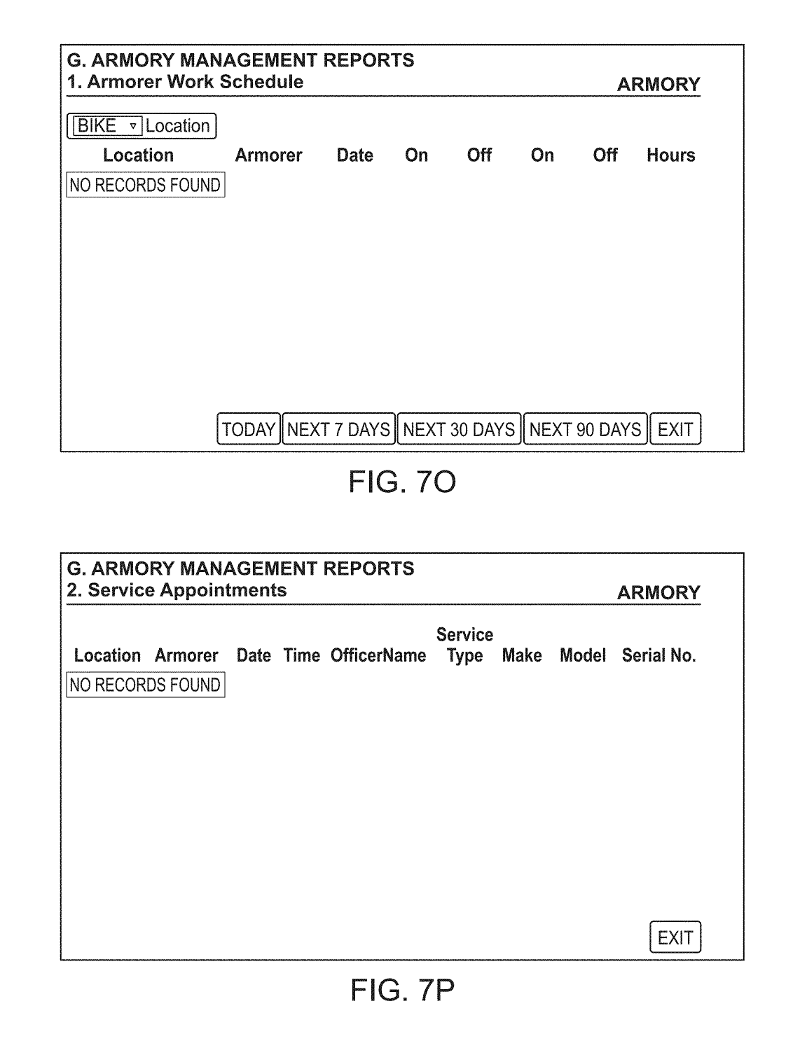

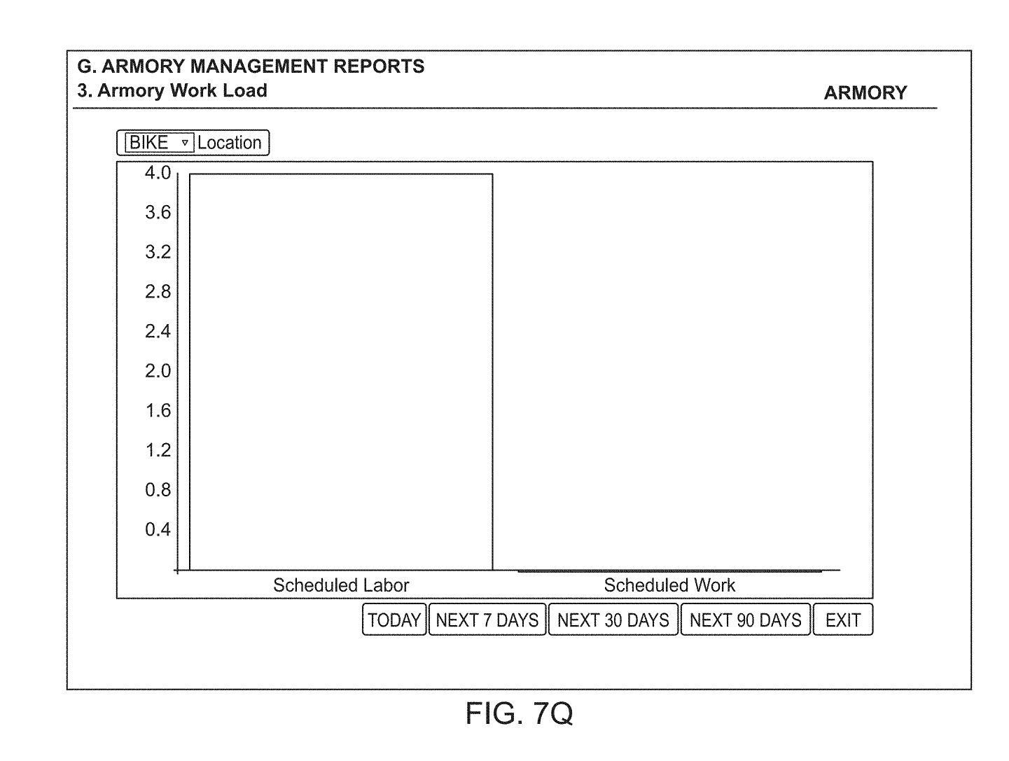

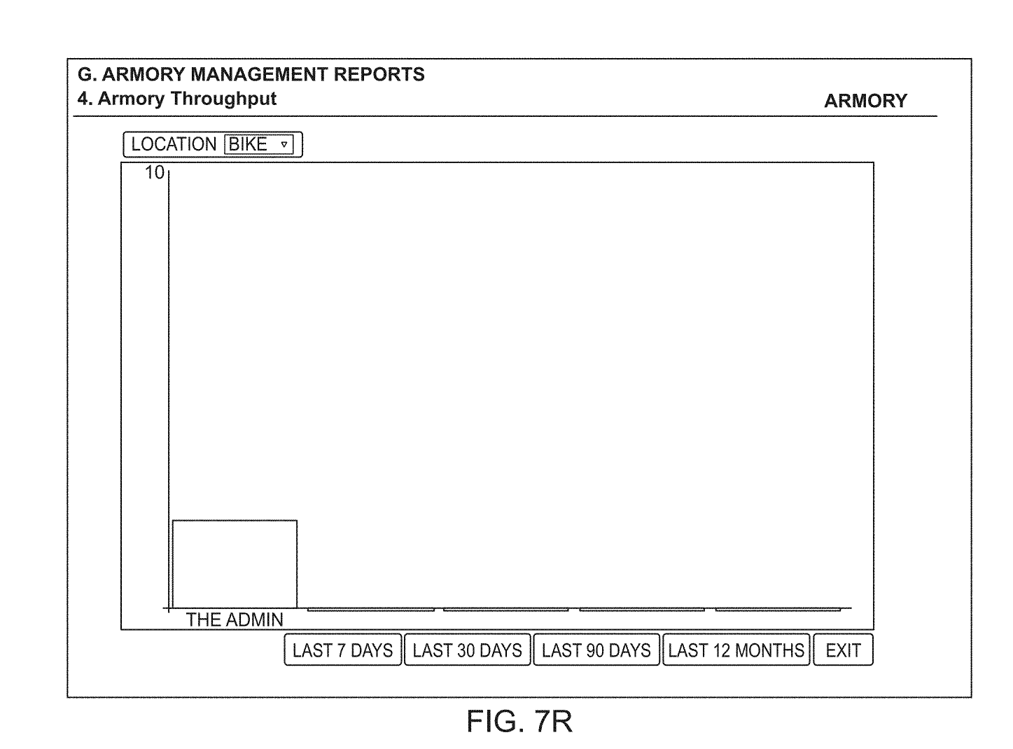

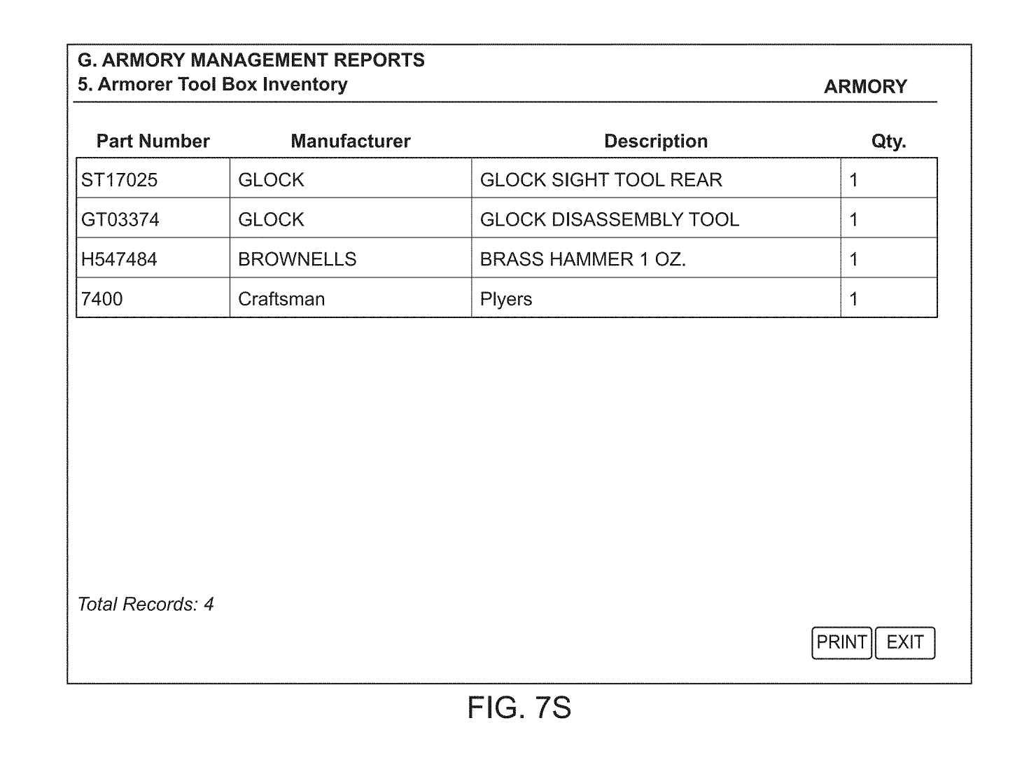

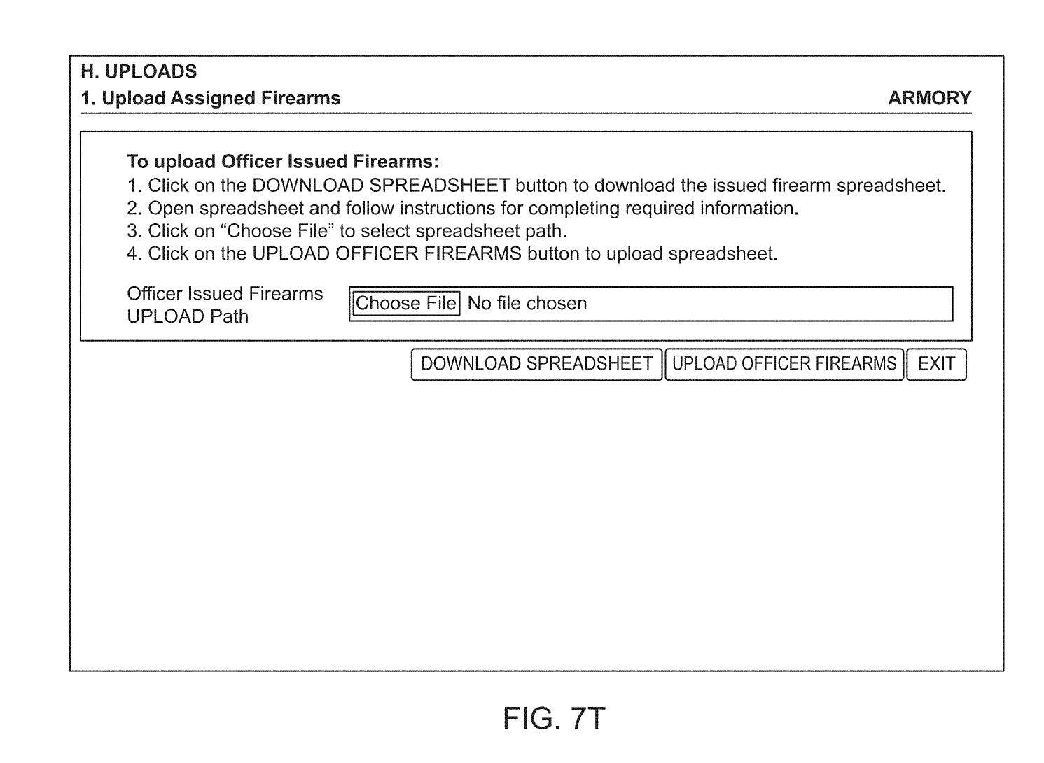

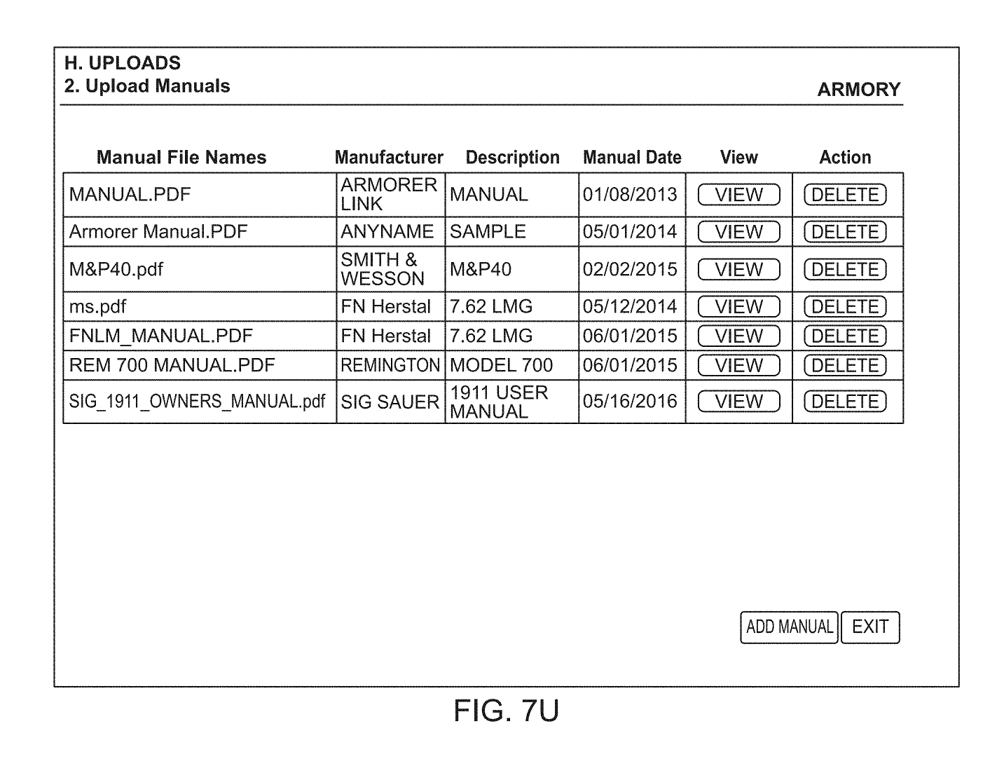

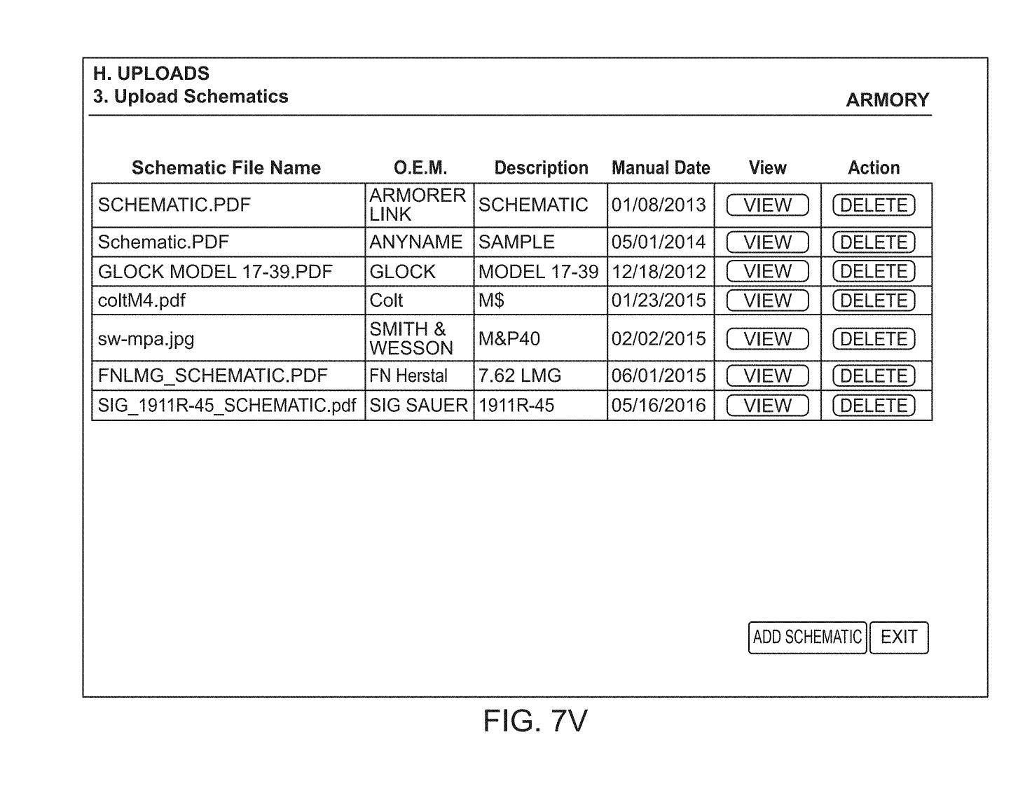

FIG. 7 is an exemplary screen view that illustrates functions for managing the firearms of a law enforcement agency consistent with embodiments of the present disclosure. These functions may include issuing a firearm to a law enforcement officer or storage locker, including the reason for the issuance and information identifying the officer, firearm, and locker (FIG. 7A); and returning an issued firearm to an armory (FIG. 7B). Other functions may include checking out a loaner firearm to an officer (FIG. 7C) and checking in a loaner firearm (FIG. 7D). Still other functions may include managing firearm work orders (FIG. 7E); maintaining information about servicing a firearm work order where such servicing may require performing routine maintenance (or repairs) on a firearm according to quality control specifications provided by a firearm manufacturer and/or law enforcement agency (FIG. 7F); and maintaining information about the service requirements and standards for a particular firearm, including without limitation, repair time, service life (by rounds and time duration), schematics, and recall information (FIG. 7G). Other functions may include maintaining information about firearms currently issued to a particular law enforcement officer (FIG. 7H). Managing the firearms of a law enforcement agency may also include maintaining an armory work schedule that identifies when an armorer may be available to service a firearm and the availability of a loaner firearm to replace the serviced firearm so that an officer can plan accordingly (FIG. 7I).

Consistent with embodiments of the present disclosure, firearm management may also include generating and maintaining firearms status reports that include: the history of a firearm (FIG. 7J); what firearms are available for issuance to a law enforcement officer (FIG. 7K); preventative maintenance information associated with an issued firearm, including last date of service and number of days past scheduled preventative maintenance (FIG. 7L); information about the number of loaner firearms currently checked out, and to whom they are checked out (FIG. 7M); and information about the number (and type) of loaner firearms that are available to loan (FIG. 7N).

Armory management functions consistent with embodiments of the present disclosure may further include generating armory management reports. For example, generating a report that may show the availability of an armorer to service a firearm so that an officer can plan accordingly, including making arrangements for a loaner firearm (FIG. 7O); generating service appointment reports that may reflect what service appointments have been booked by a particular officer, and at which armorer the appointment is booked (FIG. 7P); generating armory workload reports that may provide a snapshot of the capacity and availability of an armorer (FIG. 7Q); generating armory throughput reports that may show the amount of time an armorer has spent working on a particular firearm (FIG. 7R); and generating armory tool box inventory reports that may show the items that may be available in an armorer's tool box, which may include conventional tools (e.g., hammers, pliers, screwdrivers, center punch, and the like) and firearm specific tools (e.g., tools to assemble or disassemble a firearm, including sight alignment tools, firing pin remover tools, and the like) (FIG. 7S). Armory management functions consistent with embodiments of the present disclosure may also include uploading assigned firearm information, which may include historical information associated with an issued firearm (FIG. 7T); uploading manufacturer manuals (FIG. 7U); and uploading manufacturer schematics (FIG. 7V).

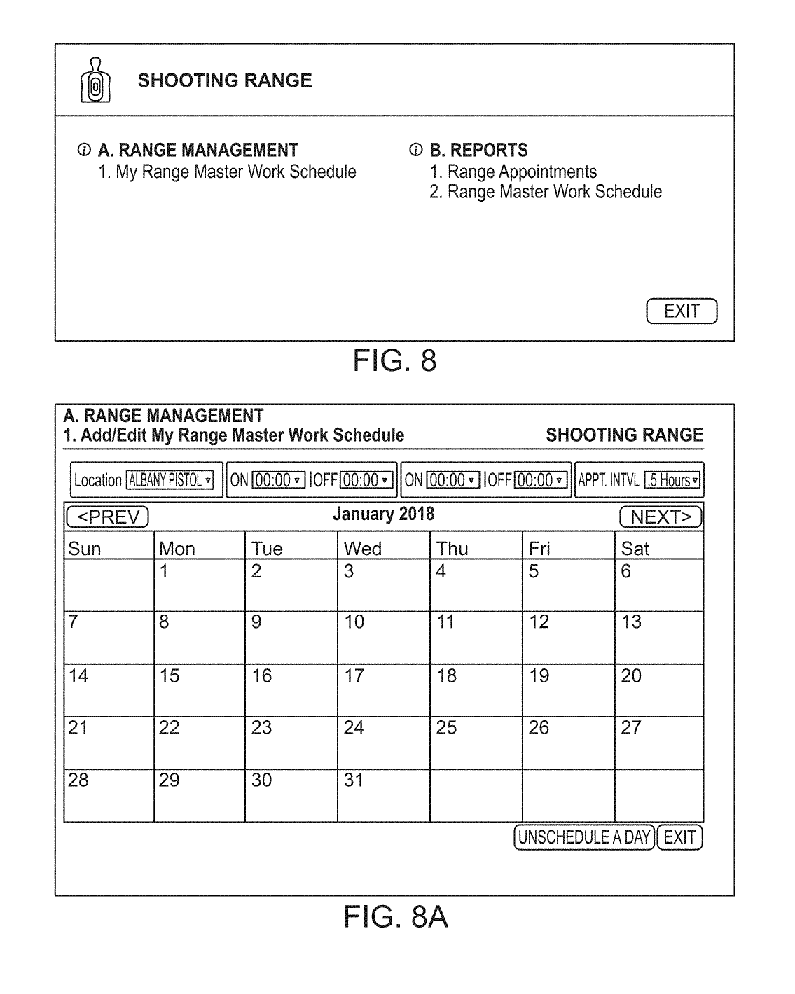

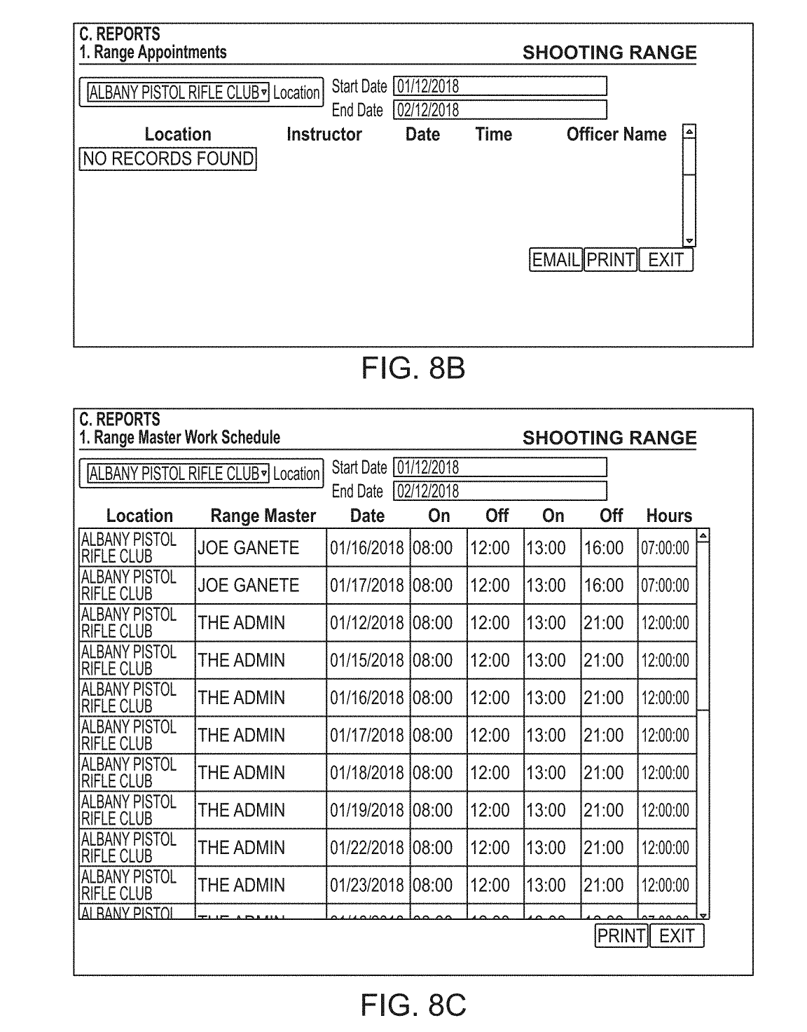

FIG. 8 is an exemplary screen view that illustrates functions for managing shooting range activities consistent with embodiments of the present disclosure. These functions may include maintaining a range master work schedule that provides a calendar of when a range master is available for scheduling (FIG. 8A), maintaining shooting range appointments according to a particular schedule (FIG. 8B), and maintaining a shooting range master work schedule that may show a comprehensive view of scheduled shooting range activities (FIG. 8C).

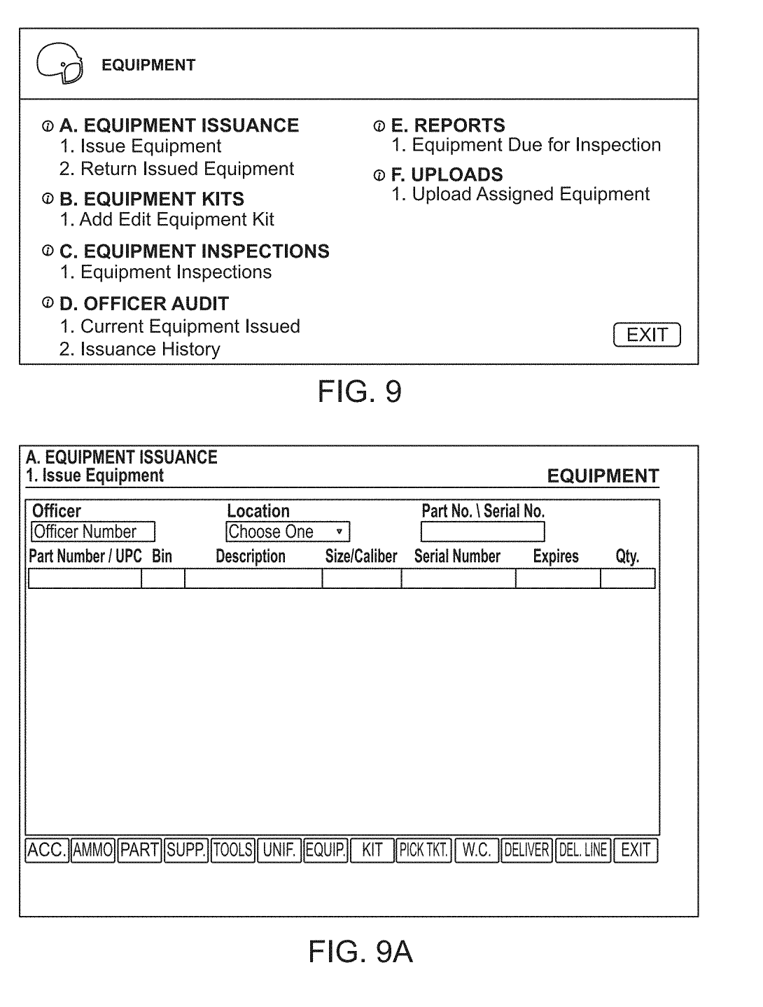

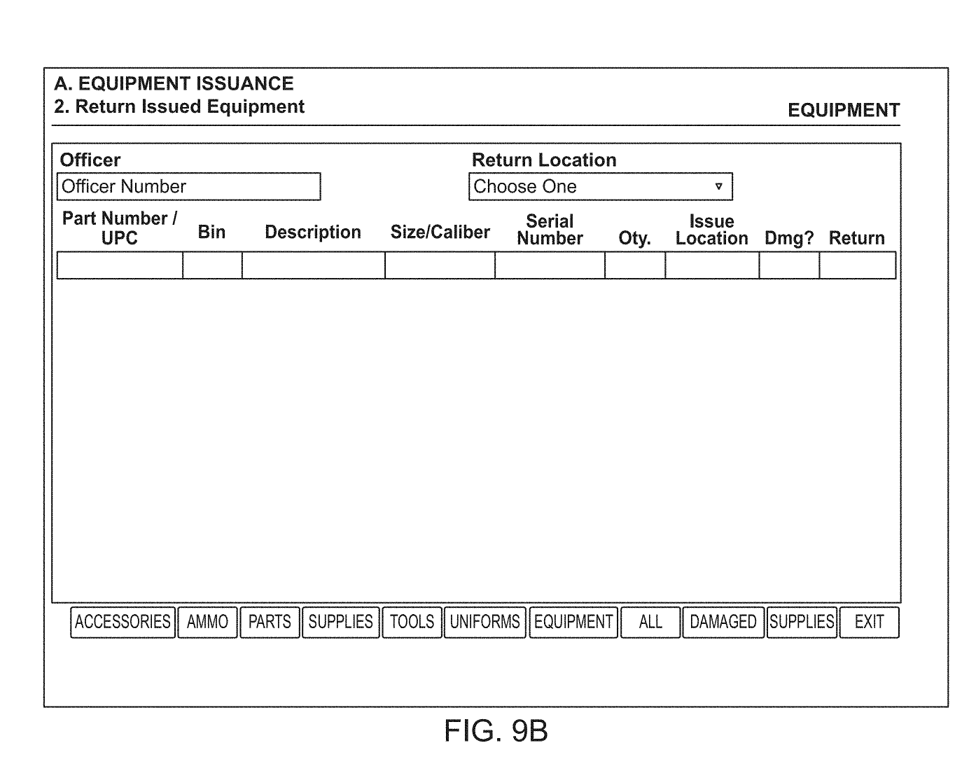

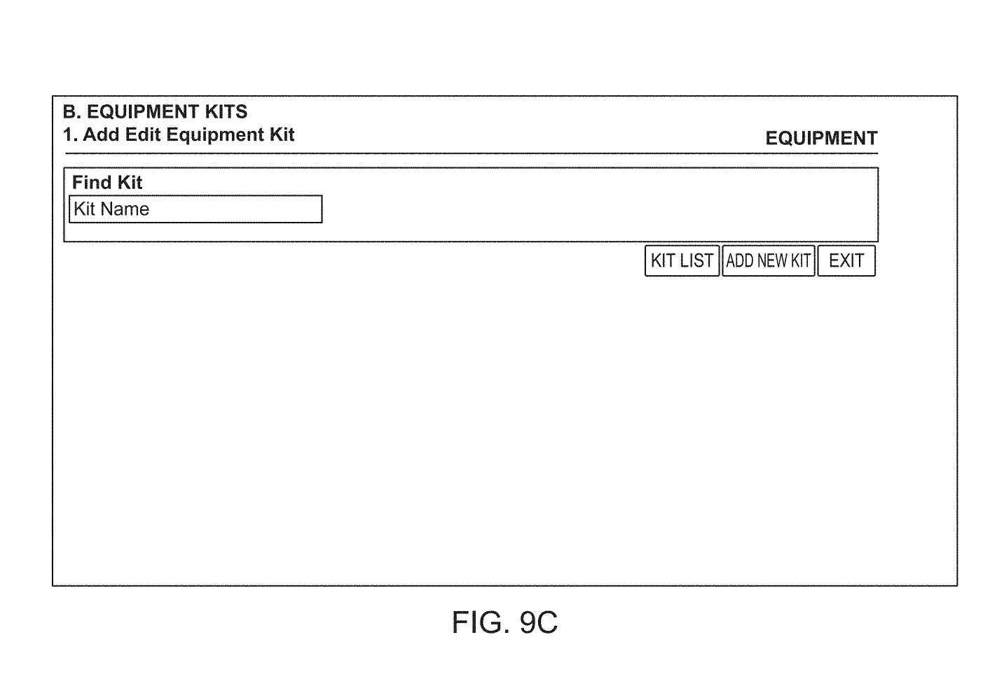

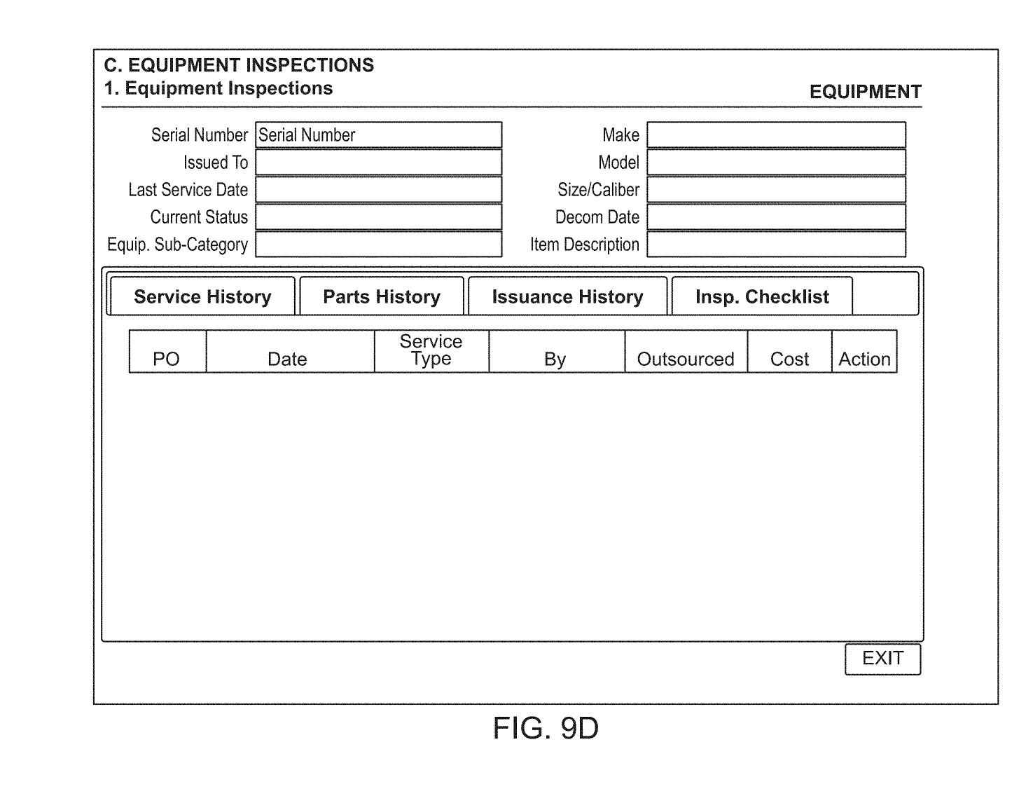

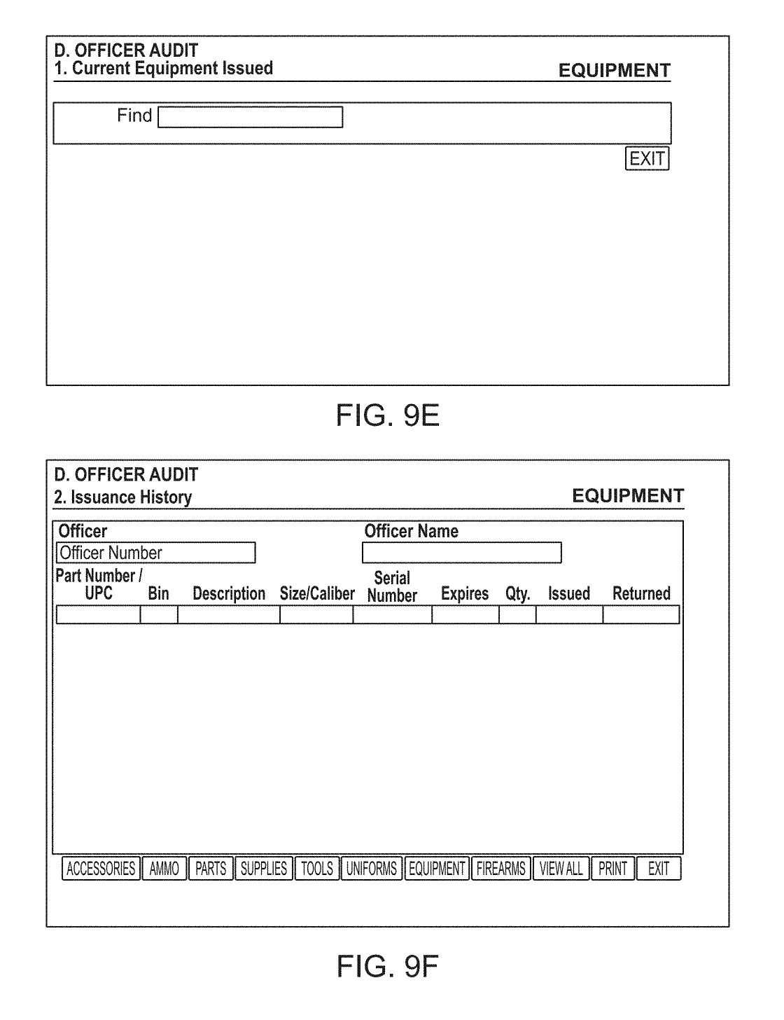

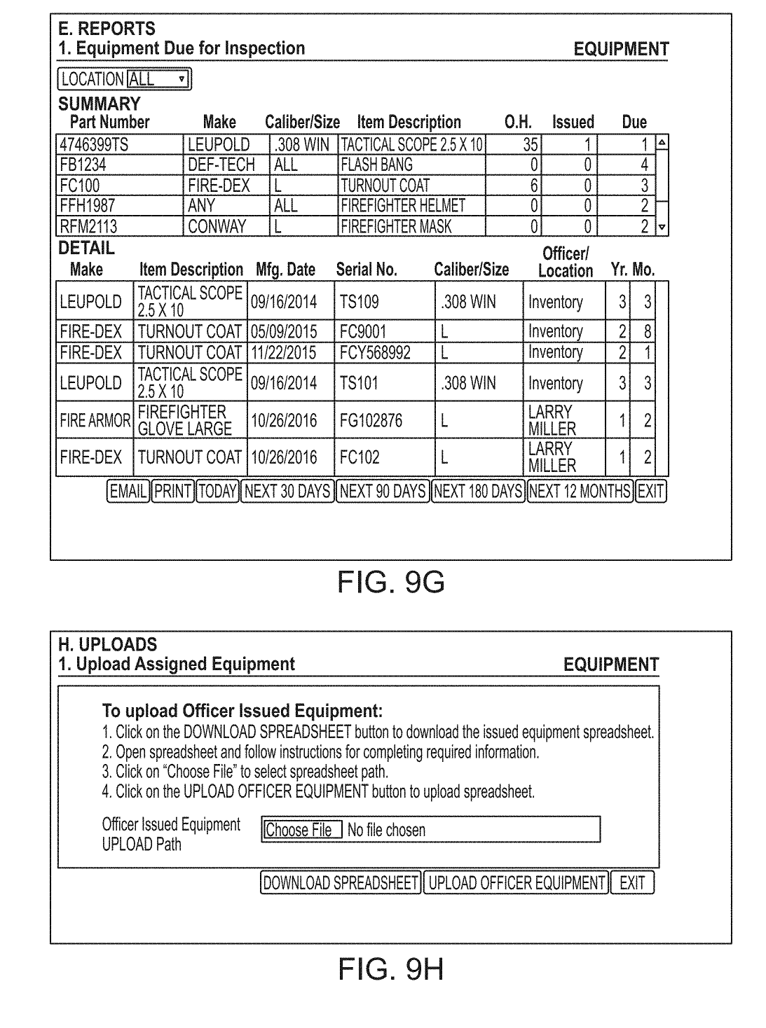

FIG. 9 is an exemplary screen view that illustrates functions for managing non-firearm law enforcement equipment consistent with embodiments of the present disclosure. These functions may include maintaining information about issued equipment, including without limitation, the officer to whom the equipment is issued and whether equipment has been placed in (or retrieved from) a storage locker (FIG. 9A); tracking and maintaining information about returned equipment (FIG. 9B); adding and modifying equipment kits (e.g., equipment that an officer may is required to use, as specified by an agency's protocol) (FIG. 9C); maintaining information about equipment inspections, including among other things, last equipment service date (FIG. 9D); maintaining information about equipment that is currently issued to law enforcement officer(s) (FIG. 9E); maintaining a history of the equipment issued to an officer (FIG. 9F); maintaining information about equipment that is due for inspection (FIG. 9G); and uploading training records associated with assigned equipment from an external file (FIG. 9H).

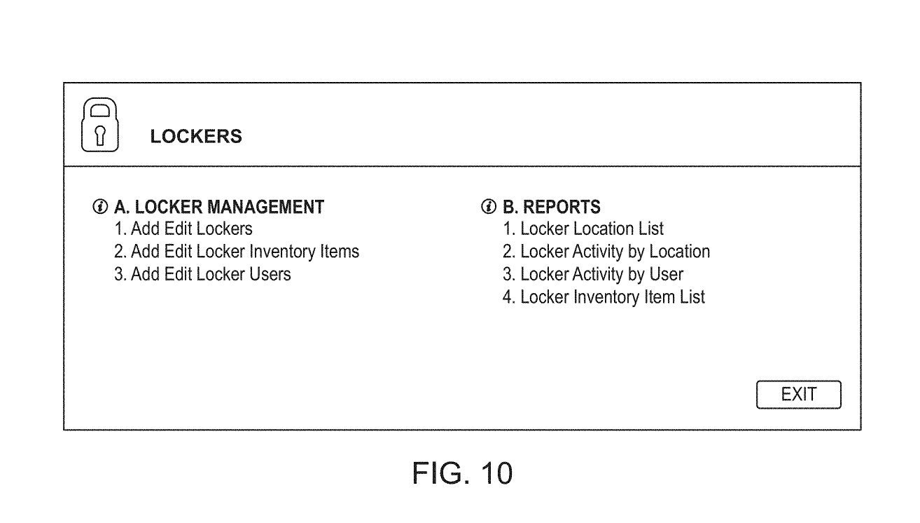

FIG. 10 is an exemplary screen view that illustrates locker management functions consistent with various embodiments of the present disclosure. As discussed above, the ability to secure communal firearms and/or equipment at a remote location where no armory, armorer, or quartermaster is available to issue firearms and/or equipment may be critical. Additionally, the ability to stage firearms or equipment for repair, or provide access to firearms and/or equipment at a remote location may also be necessary. Accordingly, an asset management system 10 disclosed herein may include a locker function (or module) that may, among other things, remotely track the activity associated with a storage locker 80.

Although the foregoing has been described in some detail for purposes of clarity, it will be apparent that certain changes and modifications may be made without departing from the principles thereof. It should be noted that there are many alternative ways of implementing both the systems and methods described herein. Accordingly, the present embodiments are to be considered as illustrative and not restrictive, and the invention is not to the details given herein, but may be modified within the scope and equivalents of the disclosed embodiment.

What is claimed is:

1. An asset management system comprising:
a back-end server coupled to a user device via a network, wherein the back-end server is configured to process information associated with one or more law enforcement agencies; and
a database server coupled to the back-end server, wherein the database server is configured to manage one or more databases,
wherein each database of the one or more databases corresponds to a unique one of the one or more law enforcement agencies, and
wherein each database of the one or more databases is configured to store a portion of the information associated with the one or more law enforcement agencies that corresponds to the unique one of the one or more law enforcement agencies.

2. The asset management system of claim 1, further comprising a front-end server coupled to the user device via the network, wherein the front-end server is configured to manage administrative services of the asset management system.

3. The asset management system of claim 2, wherein the administrative services of the asset management system include user login, authentication, or proof of authorization services.

4. The asset management system of claim 2, further comprising one or more replication servers coupled to the front-end server, wherein each of the one or more replication servers coupled to the front-end server is configured to replicate functionality of or data stored on the front-end server.

5. The asset management system of claim 1, wherein the information associated with the one or more law enforcement agencies includes what firearm or other equipment is checked out to an officer, whether the firearm or the other equipment has been lost or stolen, when the firearm or the other equipment was last serviced, whether the officer is trained to use the firearm or the other equipment, training results for the firearm or the other equipment, whether the firearm or the other equipment is available in inventory, or when components of the firearm or the other equipment need to be repaired, replaced or decommissioned.

6. The asset management system of claim 1, wherein the database server is physically or logically divided to form the one or more databases.

7. The asset management system of claim 1, wherein each of the one or more databases corresponds to a unique agency code, and wherein the unique agency code corresponds a unique law enforcement agency of the one of the one or more law enforcement agencies,

8. The asset management system of claim 1, further comprising one or more replication servers coupled to the back-end server; wherein each of the one or more replication servers coupled to the back-end server is configured to replicate data stored on the one or more databases.

9. The asset management system of claim 1, wherein the back-end server is coupled to one or more storage lockers configured to secure a firearm or other equipment at a remote location.

10. The asset management system of claim 9, wherein the back-end server is coupled to the one or more storage lockers via a landline, Bluetooth, or WiFi connection.

11. A method for managing assets of a law enforcement agency comprising:
providing a back-end server coupled to a user device via a network, wherein the back-end server is configured to process information associated with one or more law enforcement agencies; and
providing a database server coupled to the back-end server, wherein the database server is configured to manage one or more databases, wherein each database of the one or more databases corresponds to a unique one of the one or more law enforcement agencies, and wherein the database of the one or more databases is configured to store a portion of the information associated with the unique one or more law enforcement agencies that corresponds to the one of the one or more law enforcement agencies.

12. The method of claim 11, further comprising providing a front-end server configured to manage administrative services of the asset management system.

13. The method of claim 12 further comprising providing one or more replication servers coupled to the front-end server configured to replicate functionality of or data stored on the front-end server.

14. The method of claim 11, further comprising providing one or more replication servers coupled to the back-end server configured to replicate data stored in the one or more databases.

15. The method of claim 11, further comprising providing the back-end server coupled to one or more storage lockers, wherein the one or more storage locker are configured to secure a firearm or other equipment at a remote location
